(19) United States
(12) Patent Application Publication
(10) Pub. No.: US 2026/0171037 A1
(43) Pub. Date: Jun. 18, 2026

(54) INTER-OCULAR-ALIGNED, CONDITION-ADAPTIVE ILLUMINATION SCHEDULING FOR SINGLE-PANEL NEAR-EYE DISPLAYS

(71) Applicant: Meta Platforms Technologies, LLC, Menlo Park, CA (US)

(72) Inventors: Alexander Klement, Redmond, WA (US); Linghui Rao, Redmond, WA (US); Yongmin Park, Sammamish, WA (US); Ruidong Zhu, San Jose, CA (US); Nicholas Anthony Malecki, Redwood City, CA (US); Xinyu Zhu, San Jose, CA (US); Jie Xiang, San Jose, CA (US)

(21) Appl. No.: 19/397,817

(22) Filed: Nov. 21, 2025

Related U.S. Application Data
(60) Provisional application No. 63/733,299, filed on Dec. 12, 2024.

(51) Int. Cl. G09G 3/34; G09G 3/00

(52) U.S. Cl. CPC G09G 3/342; G09G 3/003; G09G 2320/0242; G09G 2320/0252; G09G 2320/0257; G09G 2320/0261; G09G 2320/041; G09G 2320/0633; G09G 2320/0693; G09G 2340/0435; G09G 2354/00

(57) ABSTRACT

A computer-implemented method is provided for operating a near-eye display that uses a single image panel divided into left-eye and right-eye regions, each with independently controllable illumination subsystems. The method includes driving the near-eye display, sensing an operating condition of the display, determining for each of the left- and right-eye regions an illumination window based at least in part on a refresh state of that region and the operating condition, and commanding the illumination subsystems to emit during the determined illumination windows while coordinating per-region emission timing to satisfy inter-ocular alignment and mitigate display-induced motion artifacts. Various other aspects are also disclosed.

### CROSS REFERENCE AND PRIORITY CLAIM TO RELATED APPLICATION

This application claims priority to U.S. Application No. 63/733,299, filed 12 Dec. 2024, the disclosure of which is incorporated, in its entirety, by this reference.

### SUMMARY

The present disclosure describes a computer-implemented method for operating a near-eye display that uses a single image panel divided into left-eye and right-eye regions, each with its own independently controllable illumination subsystem. The method involves sensing the operating condition of the display, determining an illumination window for each region based on the refresh state of the respective region and the sensed condition, and commanding the illumination subsystems to emit light during the calculated windows. The emission timing for each region is coordinated to maintain alignment between the eyes and to reduce motion artifacts that may be caused by the display.

The disclosure also describes a system that includes at least one physical processor and physical memory with computer-executable instructions. When executed, these instructions cause the processor to drive a near-eye display with a single image panel partitioned into left- and right-eye regions, each with independently controllable illumination subsystems. The system senses the operating condition of the display, determines illumination windows for each region based on the refresh state and operating condition, and commands the illumination subsystems to emit during the determined windows. The system coordinates the emission timing for each region to maintain inter-ocular alignment and mitigate motion artifacts.

Additionally, the disclosure describes a non-transitory computer-readable medium containing instructions that, when executed by a processor, cause the processor to drive a near-eye display with a single image panel divided into left- and right-eye regions and independently controllable illumination subsystems. The instructions enable the processor to sense the operating condition of the display, determine illumination windows for each region based on the refresh state and operating condition, and command the illumination subsystems to emit during the calculated windows. The instructions further coordinate the emission timing for each region to maintain alignment between the eyes and reduce display-induced motion artifacts.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is a flow diagram illustrating a method for operating a near-eye display with inter-ocular-aligned, condition-adaptive illumination scheduling.

FIG. 2 is a process diagram depicting the timing and overlap of backlight unit emissions relative to liquid crystal settling and frame transitions.

FIG. 3 is a schematic showing a brightness calculation process using duty cycle modulation and RGB intensity adjustments for power and contrast optimization.

FIG. 4 is a graph comparing color accuracy in a near-eye display system with and without global offset adjustments.

FIG. 5 is an illustration of an example artificial-reality system according to some embodiments of this disclosure.

FIG. 6 is an illustration of an example artificial-reality system with a handheld device according to some embodiments of this disclosure.

FIG. 7A is an illustration of example user interactions within an artificial-reality system according to some embodiments of this disclosure.

FIG. 7B is an illustration of example user interactions within an artificial-reality system according to some embodiments of this disclosure.

FIG. 8A is an illustration of example user interactions within an artificial-reality system according to some embodiments of this disclosure.

FIG. 8B is an illustration of example user interactions within an artificial-reality system according to some embodiments of this disclosure.

FIG. 9 is an illustration of an example wrist-wearable device of an artificial-reality system according to some embodiments of this disclosure.

FIG. 10 is an illustration of an example wearable artificial-reality system according to some embodiments of this disclosure.

FIG. 11 is an illustration of an example augmented-reality system according to some embodiments of this disclosure.

FIG. 12A is an illustration of an example virtual-reality system according to some embodiments of this disclosure.

FIG. 12B is an illustration of another perspective of the virtual-reality systems shown in FIG. 12A.

FIG. 13 is a block diagram showing system components of example artificial- and virtual-reality systems.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

Near-eye display systems, particularly those employing a single image panel partitioned into left-eye and right-eye regions, have historically encountered several technical challenges that impact visual fidelity and user comfort. Conventional designs often suffer from display ghosting, motion-to-photon latency, and brightness disparity between the two regions, especially in liquid crystal display (LCD) architectures. These limitations can result in perceptible artifacts, motion sickness, and diminished immersion, particularly during rapid head movements or when viewing dynamic content. The slow response time of liquid crystals further exacerbates ghosting, while the lack of precise inter-ocular alignment in emission timing can introduce temporal disparities that negatively affect the user's visual experience.

To address these issues, the disclosed subject matter provides a system and method for inter-ocular-aligned, condition-adaptive illumination scheduling in single-panel near-eye displays. The approach utilizes a single image panel divided into left-eye and right-eye regions, each with independently controllable illumination subsystems. The system senses operating conditions such as panel temperature, refresh rate, and scanout position, and determines an illumination window for each region based on the refresh state and the sensed condition. By commanding the illumination subsystems to emit light during the calculated windows and coordinating the emission timing for each region, the system maintains alignment between the eyes and reduces motion artifacts. This temperature-dependent backlight timing mechanism ensures that liquid crystals have sufficient time to settle before illumination, thereby mitigating ghosting and reducing latency.

Additionally, the subject matter incorporates a content-adaptive duty cycle algorithm to optimize power consumption and contrast. By modulating the backlight duty cycle in response to content characteristics, the system achieves power savings while preserving perceived brightness and enhancing contrast. The solution further includes a global offset calibration to correct thermal-induced color shifts, ensuring consistent color accuracy across varying operating conditions. Through these integrated advancements, the described technology delivers improved visual fidelity, reduced latency, enhanced color accuracy, and increased user comfort in near-eye display applications.

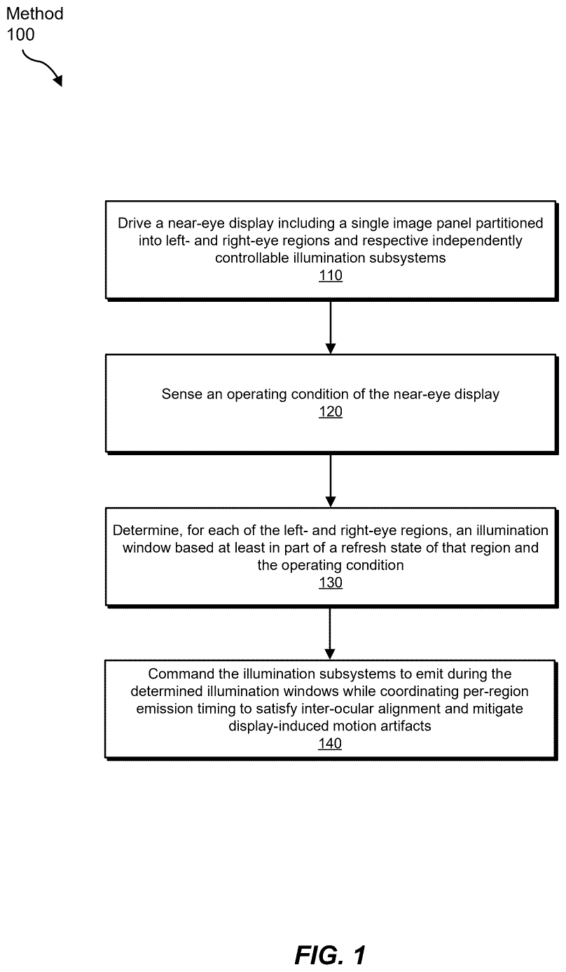

FIG. 1 illustrates an example method 100 for driving a near-eye display with inter-ocular-aligned, condition-adaptive illumination scheduling. The method is shown as a series of steps (110, 120, 130, and 140) that can be executed by one or more physical processors operating in electronic communication with a single image panel and independently controllable illumination subsystems. Although FIG. 1 presents the steps in a particular order, the steps can be performed in different orders, concurrently, iteratively, or with steps omitted or added, as the method is not limited to any fixed sequence.

A “near-eye display” is a display that presents images within a short optical path distance of a user's eye (e.g., a head-mounted display, smart glasses, or other artificial-reality eyewear). An “image panel” is any display panel configured to render pixel imagery, including but not limited to liquid-crystal displays (LCD), liquid-crystal-on-silicon (LCOS), micro-LED panels, OLED-on-silicon, or waveguide-coupled projection displays. An “illumination subsystem” is a light-emitting component or assembly used to illuminate the image panel or otherwise provide controlled emission, such as a backlight unit (BLU), segmented strobed emitters, global shutters with strobing, micro-projector light sources, or other optical illuminators. “Independently controllable” means that each illumination subsystem can be turned on, turned off, modulated, phase-shifted, or duty-cycled without forcing the identical behavior on another illumination subsystem.

Step 110 is directed to driving a near-eye display including a single image panel partitioned into left- and right-eye regions and respective independently controllable illumination subsystems. In one embodiment, a single LCD panel is mechanically and electronically partitioned such that pixels in a first region correspond to imagery for a left eye and pixels in a second region correspond to imagery for a right eye. In this embodiment, a left BLU is optically coupled to the left region and a right BLU is optically coupled to the right region, and each BLU can be strobed separately. In another embodiment, the illumination subsystem is segmented across the single panel, with segments assigned to the left and right regions and driven independently to emulate two backlights without requiring separate BLU modules. In some embodiments, the illumination subsystems are independently controllable backlights disposed behind the image panel.

In other embodiments, the illumination subsystems have segmented illumination sources arranged as zones that can be strobed independently for the left- and right-eye regions, including zone arrays of LEDs or micro-LEDs that form optical fields aligned to the respective regions. Either approach allows the system to constrain emission to the pixels of a given eye region at a chosen time.

The single image panel can be rotated relative to the optical axis of the lenses, such that the panel's raster scan progresses in opposite directions for the two eye regions. This rotation causes the refresh state of the left-eye region to advance, for example, left-to-right while the right-eye region advances right-to-left, creating a timing asymmetry that the disclosed scheduling compensates. The rotated configuration is useful in head-mounted systems where mechanical packaging dictates panel orientation, and the software adapts to this orientation for inter-ocular alignment.

Driving the near-eye display includes supplying pixel data, synchronizing frame and line timing, calibrating gamma and color, and commanding illumination subsystems with per-region control signals. In one embodiment, the processor writes left-eye pixel data to the left region and right-eye pixel data to the right region while managing MIPI-DSI link timing to ensure line scan intervals that support the scheduled illumination windows. In another embodiment, a compositor or display processing unit performs chromatic aberration correction (CAC) on rendered images prior to panel write, and the scheduling accounts for CAC pipeline latency.

The system can implement brightness disparity calibration between regions. In one embodiment, the processor measures or estimates optical output from each illumination subsystem and adjusts left BLU current relative to right BLU current to equalize perceived brightness across eyes. The calibration may be static, applied at manufacture, or dynamic, applied during use based on sensor readings or user feedback, and may be used in conjunction with the scheduling described in later steps.

Step 120 is directed to sensing an operating condition of the near-eye display. As used herein, an “operating condition” is any state variable that influences panel behavior, illumination behavior, or system timing, including temperature, refresh rate, supply voltage, illumination subsystem temperature, ambient temperature, content classification, panel age, motion state, or head pose. The operating condition may be at least temperature, such as panel temperature measured by a thermistor adhered to the panel or an on-panel temperature sensor embedded in the display stack.

In some embodiments, the operating condition includes one or more of ambient temperature measured by a housing sensor, panel temperature measured by a sensor thermally coupled to the panel, the current refresh rate (e.g., 90 Hz vs. 120 Hz), supply voltage delivered to the BLUs, illumination subsystem temperature measured by a sensor on the BLU board, or panel age inferred from operating hours. Each of these factors can influence liquid-crystal response, LED efficiency, and timing stability, and therefore the scheduling must adapt.

Sensing can include reading a motion state of the near-eye display or the user's head pose. In one embodiment, inertial measurement units (IMUs) provide gyroscope and accelerometer data that reveal head rotation velocity and acceleration, and the system adjusts per-region emission timing to better align with predicted head motion and reduce motion-to-photon latency. In another embodiment, inside-out cameras track head pose and supply pose updates to the scheduler, which may slightly advance or delay the windows to minimize perceptual lag.

Panel refresh information can also be treated as an operating condition input. For example, the system may read a line or row index from a timing controller, detect a frame boundary signal, or determine a region update completion indicator exposed by the display driver. These signals, discussed further with step 130, inform the precise moment when a region is sufficiently written to consider emission and are examples of sensing a “refresh state.”

Temperature sensing can be performed with multiple sensors. In one embodiment, a panel sensor reports a temperature that tracks liquid-crystal viscosity, while a BLU sensor reports LED junction temperature that affects luminous flux. The system can combine these readings to infer a composite “temperature condition” for scheduling. In another embodiment, ambient temperature is fused with panel temperature using weighted averages to increase stability across environments.

Supply voltage sensing can help manage duty cycles and brightness uniformity. In one embodiment, the power management integrated circuit (PMIC) reports the BLU rail voltage and, when sag is detected, the scheduler reduces duty in a non-critical region to maintain stability and avoid flicker. Panel age can be tracked to adjust timing margins as liquid crystals and LEDs degrade; for example, after a threshold number of operating hours, the settling interval may be increased by a small margin to preserve artifact-free presentation.

Step 130 is directed to determining, for each region, an illumination window based at least in part on a refresh state of that region and the operating condition. As used herein, a “refresh state” is a state variable indicating progress of image data being written to the region, including but not limited to a scanout position, a line or row index, a region update completion indicator, or a frame boundary indicator. In one embodiment, the refresh state is the last line written to a region and the scheduler computes when that line and subsequent lines will settle given the liquid-crystal response at the current temperature.

An “illumination window” is generally a time interval during which an illumination subsystem emits light to present the image. The window's start and end may be computed to occur after sufficient pixel settling and before the next frame begins to avoid smearing. In one embodiment, the window width is proportional to duty cycle and the window position is placed after a settling time obtained from a response model.

The system can model, for each region, a response characteristic of the image panel as a function of the operating condition, and determine the illumination window based at least in part on a settling time obtained from the model. In one embodiment, the response model maps temperature to liquid-crystal rise and decay times for typical gray-to-gray transitions, and the scheduler selects a window start equal to the refresh completion time plus the modeled rise time for the predominant gray levels of the frame. In another embodiment, the response model incorporates voltage and age to adjust the settling curve.

The refresh state may be influenced by panel rotation relative to the optical axis. When the single panel is rotated, the left region may scan in one direction while the right region scans in the opposite direction. The scheduler accounts for this by computing distinct refresh completion times for each region, and then determining windows that are both aligned across the eyes and placed sufficiently after region-specific settling.

Operating condition inputs other than temperature can influence window placement. For example, at higher refresh rates (e.g., 120 Hz), line times are shorter, so the scheduler may reduce duty or shift windows earlier to fit within the frame budget while still meeting settling criteria. When supply voltage dips, the scheduler may shorten window duration to prevent brown-out while maintaining minimum brightness expectations.

In some embodiments, the illumination windows overlap in time. Overlap can be beneficial for inter-ocular alignment when refresh completion times are slightly staggered. For example, the left window may start slightly after left region settling and the right window may start slightly after right region settling, and the scheduler ensures their overlap is within a target alignment tolerance so both eyes perceive near-simultaneous presentation.

Content characteristics can influence window duration. The scheduler can content-adaptively modulate illumination duty within at least one illumination window and compensate perceived brightness responsive to duty modulation by adjusting effective luminance via pixel drive or illumination amplitude. In one embodiment, darker scenes trigger reduced duty to lower persistence while the compositor increases RGB pixel values to preserve perceived brightness, resulting in improved contrast and reduced BLU power.

Head motion state can also adjust window determination. When the IMU reports a rapid yaw rotation, the scheduler may slightly advance both windows to reduce motion-to-photon latency while preserving inter-ocular alignment, thereby reducing perceptual lag during fast head movements. Alternatively, during static scenes the scheduler may extend window duration to afford higher brightness while still avoiding artifacts. In many embodiments, determining windows includes enforcing an inter-ocular temporal disparity constraint. The constraint can be expressed as a maximum allowable time offset between the illumination windows, such as an offset not exceeding a perceptual threshold calibrated through testing. The scheduler selects window positions that satisfy this constraint while preserving settling-based artifact reduction, thereby harmonizing the two objectives.

The scheduler can adapt to pipeline variations. Determining windows can include adjusting a data link rate (e.g., MIPI rate increase) or pipeline scheduling to align the refresh state with coordinated emission timing. In one embodiment, the system increases MIPI-DSI rate during high-motion scenes to shorten line times and expand the margin available for window placement without increasing latency.

Chromatic aberration correction (CAC) latency can be accommodated. Performing CAC in a system-on-chip may add processing latency, and the scheduler can account for this by basing refresh state on the post-CAC write timing to the panel, not the pre-CAC render timing, ensuring windows are aligned with actual panel update completion.

Step 140 is directed to commanding the illumination subsystems to emit during the determined illumination windows while coordinating per-region emission timing to satisfy inter-ocular alignment and mitigate display-induced motion artifacts. As used herein, “coordinating” includes issuing control signals such that the left and right illumination subsystems emit according to their respective windows and such that the temporal relationship between the windows meets the inter-ocular alignment constraint.

In one embodiment, the processor drives GPIOs or dedicated BLU drivers with precise timing marks to strobe each backlight at the computed window start and to maintain the window duration. The control can apply pulse-width modulation for duty setting, current setting for amplitude, and phase alignment signals to attain the target inter-ocular timing. In another embodiment, the control is performed via an illumination controller that receives scheduled windows as timestamps and executes strobing autonomously.

Mitigating display-induced motion artifacts includes suppressing ghosting and smearing. In an LCD embodiment, the illumination is commanded after a settling interval derived from the temperature-dependent liquid-crystal response, so that most pixels have reached target states and the strobed presentation does not reveal intermediate transition states. In an emissive panel embodiment, the coordination can reduce perceived judder by ensuring both eyes present the frame within the same perceptual moment, even if scan patterns differ. The coordination can include overlap or stagger strategies. For example, when the left region settles slightly earlier than the right region, the scheduler may begin the left window at its earliest acceptable time, begin the right window at its earliest time, and ensure the overlap duration satisfies the inter-ocular temporal disparity constraint. When overlap is not feasible due to frame budget, the windows may be tightly staggered within the constraint to create near-simultaneous perception.

In some embodiments, the system reduces motion-to-photon latency by advancing at least one illumination window while maintaining inter-ocular alignment. For example, during rapid head rotations, advancing both windows by a small amount relative to typical placement can reduce perceived lag, provided the advance does not violate the settling criterion. The amount of advance can be computed using motion prediction based on IMU data and rendering pose estimation.

The coordination can also incorporate brightness disparity calibration between regions. In one embodiment, commanding emission includes setting left and right BLU currents differently to equalize perceived brightness while preserving the scheduled window timing. The calibration can be based on measurements during manufacturing or during runtime using an optical sensor or user feedback mechanisms.

Global color and gamut adjustments can operate alongside the scheduling. In one embodiment, a global white-point offset is applied to correct thermal-induced color shifts. This color correction occurs in the pixel pipeline and does not change window timing, but the scheduler may monitor processing latency of color correction and include it in refresh-state determinations, ensuring coordination remains accurate.

Power optimization can be integrated with the window command. Content adaptive duty control (CADC) can reduce BLU duty in low-to-mid gray regions to save power while increasing RGB values or illumination amplitude to preserve brightness. The scheduler's window duration naturally reflects duty changes, and the coordination maintains inter-ocular alignment regardless of duty settings. Experiments involved game and productivity scenarios where BLU power reductions of up to approximately 0.46 W were observed, and the method accommodates such savings without sacrificing alignment.

In some embodiments, the system measures results and feeds back into scheduling. For example, sensors indicate whether frame boundaries drift due to temperature-induced timing variations, and the scheduler adjusts window placement accordingly. The coordination layer can also record whether the inter-ocular temporal disparity constraint is consistently met and tune parameters to maintain alignment across device aging, voltage variation, and environmental changes.

The method supports alternative display technologies. In an LCOS embodiment with projector illumination, the illumination subsystem is the projector light source and shutter mechanism, and the scheduling controls projector pulses for left and right regions. In a micro-LED embodiment, the illumination subsystem can be on-panel emissive drivers with strobe capability, and the scheduling coordinates segment strobing per region. In each case, per-region timing is coordinated for alignment and artifact mitigation, and the determination of windows uses technology-appropriate response models.

The method can be implemented across various devices and device types. While the algorithm has been explained for a single-panel LCD headset, many features generalize to other programs, including displays that support adjustable illumination. Significant development resides in sensing operating conditions, determining per-region windows based on refresh state and the conditions, and coordinating emission to satisfy inter-ocular alignment while mitigating motion artifacts on a single panel with independent per-eye illumination.

“Perceived brightness” generally refers to brightness as perceived by a typical user under typical viewing conditions and can be preserved by adjusting either pixel drive (e.g., RGB intensity values) or illumination amplitude (e.g., BLU current) or both. “Duty cycle” generally refers to the fraction of a frame during which an illumination subsystem emits and can be modulated to adjust persistence, power, and contrast. “Motion-to-photon latency” is the elapsed time between a user motion and the corresponding image update appearing to the user; it can be reduced by scheduling windows closer to the end of refresh while respecting settling and alignment constraints.

“Inter-ocular temporal disparity constraint” generally refers to a constraint that limits the relative timing difference between left and right region illumination, such that the perceived temporal alignment remains within a threshold determined by human perception experiments or device specifications. “Settling interval” is a time margin after refresh completion during which the panel or pixels reach a stable state; the interval can be derived from modeled response or empirical calibration and can vary with operating condition.

“Scanout position” and “line or row index” generally refer to raster coordinates indicating progression of data writing across the panel; a “region update completion indicator” is a signal that indicates the left or right region has been fully written for a frame; a “frame boundary indicator” is a signal that marks the end or start of a frame. “Data link rate” generally refers to the transmission rate over the display interface (e.g., MIPI-DSI) and can be adjusted to align refresh timing; “pipeline scheduling” refers to ordering and timing of rendering, image processing (including CAC), and panel write operations.

“Chromatic aberration correction” is an image processing operation that compensates for optical dispersion in lenses by spatially remapping or color-shifting pixels to correct perceived fringes; performing CAC may introduce additional processing latency, and the scheduler accounts for it when computing refresh-state timing. “Head pose” is the orientation and position of the user's head; sensing head pose can be used to predict the desired presentation moment and fine-tune window placement.

While the preceding paragraphs describe particular embodiments and examples, other variations can be used. The scheduler can be adaptive or rule-based, can incorporate machine learning models trained on device behavior across temperatures, and can expose configuration parameters to developers or users. The coordination can be performed in firmware, driver software, or dedicated hardware blocks, and may be updated post-manufacture via software updates.

In summary, step 110 establishes the single-panel, dual-illumination architecture and rendering drive; step 120 senses one or more operating conditions including temperature and motion; step 130 computes per-region illumination windows using refresh state and the sensed conditions, enforcing inter-ocular constraints and settling criteria; and step 140 commands emission while coordinating per-region timing to maintain inter-ocular alignment and mitigate display-induced motion artifacts, with optional integrations for duty modulation, brightness compensation, latency reductions, data link adjustments, and color corrections.

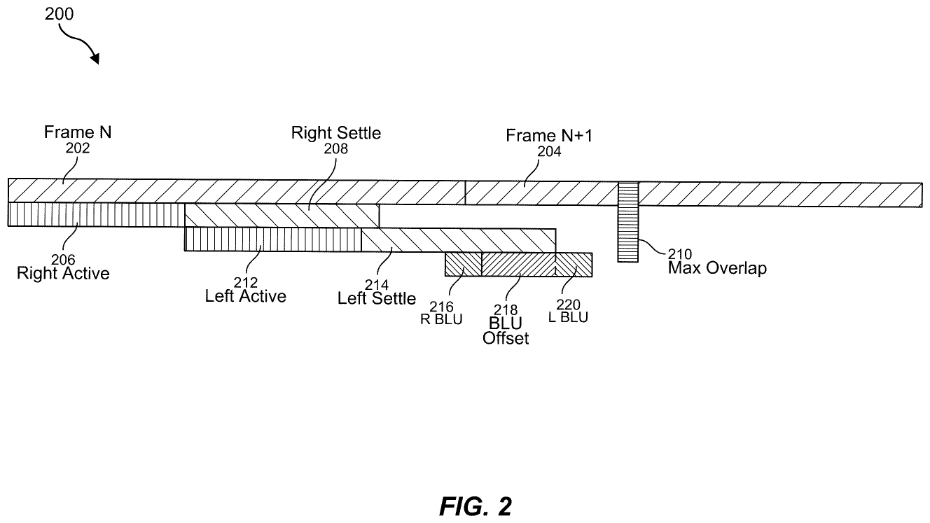

FIG. 2 illustrates a process diagram depicting the timing and overlap of backlight unit emissions relative to liquid crystal settling and frame transitions in a near-eye display system. The diagram includes several components that interact to coordinate emission timing and mitigate display-induced motion artifacts.

Frame N 202 represents the time interval corresponding to a display refresh cycle, serving as a temporal reference for subsequent operations such as scanout, settling, and illumination for both left-eye and right-eye regions. Right active 206 indicates the period during which image data is written to the right-eye region, initiating liquid crystal transitions in that region. Right settle 208 denotes the interval allowing liquid crystal pixels in the right-eye region to complete their transition to target states, with timing influenced by response characteristics and panel temperature. Max overlap 210 specifies the maximum allowable temporal overlap between illumination windows of left BLU 220 and right BLU 216, constrained by inter-ocular alignment requirements. Frame N+1 204 marks the beginning of the next refresh cycle, initiating new scanout and illumination processes.

Left settle 214 defines the settling period for liquid crystal pixels in the left-eye region, ensuring transitions are complete before illumination. Right BLU 216 corresponds to activation of the right backlight unit, timed to follow completion of right settle 208 and independently controlled to adapt to operating conditions. BLU Offset 218 represents the temporal offset between activation of right BLU 216 and left BLU 220, calibrated to account for differences in scanout and settling times. Left BLU 220 indicates activation of the left backlight unit, synchronized with completion of left settle 214 and independently controlled for precise timing. Left active 212 marks the period during which image data is written to the left-eye region, occurring after right active 206 due to sequential scanout in the rotated single-panel architecture. Each component contributes to coordinated emission timing, alignment between eye regions, and reduction of motion artifacts in the display system.

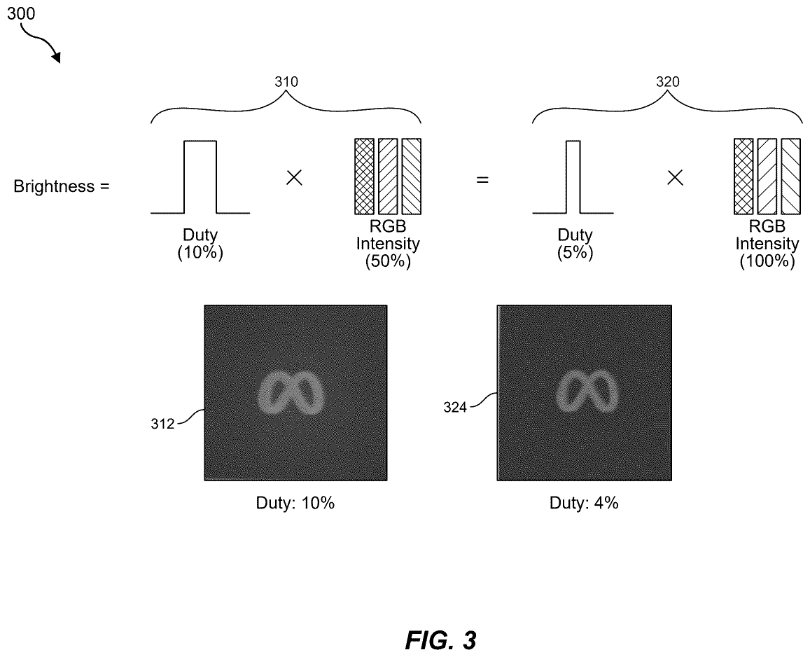

FIG. 3 illustrates a brightness calculation process using duty cycle modulation and RGB intensity adjustments for power and contrast optimization in a near-eye display system. Brightness calculation formula 300 defines the relationship between duty cycle and RGB intensity, where brightness is determined by multiplying duty cycle and RGB intensity. Duty cycle representation 310 shows a configuration with a 10% duty cycle and 50% RGB intensity, demonstrating a balance between backlight activation and pixel drive values. Visual representation 312 depicts the resulting image quality when duty cycle is set to 10% and RGB intensity is at 50%, maintaining perceived brightness through compensatory adjustment. Duty cycle representation 320 presents a scenario with a 5% duty cycle and 100% RGB intensity, illustrating further reduction in backlight usage while increasing pixel drive to preserve brightness. Visual representation 324 displays the image quality when duty cycle is reduced to 5% and RGB intensity is set to 100%, showing that perceived brightness is maintained despite lower backlight activation.

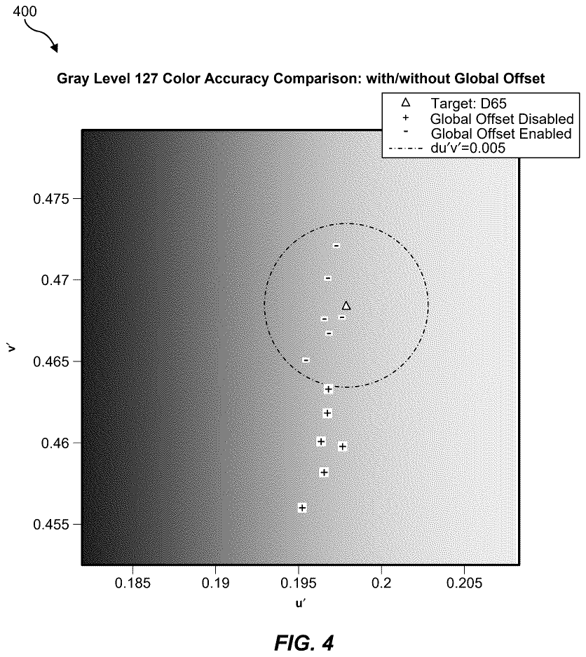

FIG. 4 is a graph 400 comparing color accuracy in a near-eye display system under two calibration conditions: with global offset adjustments and without global offset adjustments. The system includes a single image panel partitioned into left- and right-eye regions and respective independently controllable illumination subsystems. The system is configured to sense an operating condition of the near-eye display, determine, for each region, an illumination window based at least in part on a refresh state of that region and the operating condition, and command the illumination subsystems to emit during the determined illumination windows while coordinating per-region emission timing to satisfy inter-ocular alignment and mitigate display-induced motion artifacts. In some aspects, the operating condition comprises at least temperature, and may include ambient temperature, panel temperature, refresh rate, supply voltage, illumination subsystem temperature, or panel age. The system may further model, for each of the left- and right-eye regions, a response characteristic of the image panel as a function of the operating condition, and determine the illumination window based at least in part on a settling time obtained from the model.

In the context of FIG. 4, the graph 400 illustrates the effect of global offset calibration on color accuracy by plotting chromaticity coordinates for gray level 127 under two conditions. The chromaticity coordinates are shown in a two-dimensional color space, with the x-axis corresponding to u′ chromaticity values and the y-axis corresponding to v′ chromaticity values. The system may compensate perceived brightness responsive to duty modulation by adjusting effective luminance via pixel drive or illumination amplitude. For example, the system may implement a global offset to correct thermal-induced color shifts, resulting in improved color accuracy across varying operating conditions. The global offset calibration is applied in the pixel pipeline and does not change window timing, but the scheduler may monitor processing latency of color correction and include the latency in refresh-state determinations, ensuring coordination remains accurate.

The graph includes two sets of data points: “+” (plus) markers represent chromaticity coordinates when global offset adjustments are applied, and “−” (minus) markers represent coordinates without global offset adjustments. A dashed circle is overlaid to indicate a tolerance region for acceptable color accuracy, providing a visual reference for evaluating the effectiveness of the calibration. The “+” markers are more closely clustered within the tolerance region, showing that the global offset calibration can correct thermal-induced color shifts and maintain consistent color accuracy. This is an example of how the system compensates for variations in operating conditions, such as temperature changes, by adjusting the pixel drive or illumination amplitude to preserve perceived brightness and color fidelity.

In comparative embodiments, single-panel systems that naïvely strobe both per-eye illumination subsystems at exactly the same instant, regardless of the per-region refresh state, can introduce substantial inter-ocular latency imbalance and perceptual disparity. When one region has just completed scanout and the other is earlier in its scan, a simultaneous flash forces one eye to present pixels nearer their settled target while the other eye presents pixels mid-transition, which can manifest as temporal judder, binocular discomfort, and motion sickness. The disclosed scheduler avoids this failure mode by determining per-region windows from region-specific refresh state and sensed conditions, and by coordinating those windows to satisfy an inter-ocular alignment constraint while still honoring stability criteria for each region.

In another comparative baseline, a single backlight shared across both regions can be strobed only after the later region completes its refresh. While this approach can reduce ghosting compared to simultaneous dual flashes, it imposes an avoidable latency penalty on the earlier region and increases motion-to-photon latency asymmetrically across the eyes. The single backlight alternative also complicates brightness equalization and power management because the entire panel must be driven to meet the slowest settling path. The disclosed dual-illumination architecture preserves both low latency and artifact suppression by allowing each region to emit as soon as its modeled settling interval is satisfied, subject to inter-ocular alignment. Further details of content adaptive duty control (CADC) are now provided. CADC can operate as a temporal dimming mechanism that reduces illumination duty in response to scene luminance, contrast targets, or noise measurements while preserving perceived brightness by increasing pixel drive or illumination amplitude. In one embodiment, CADC gradually reduces duty toward a floor of approximately twenty percent even in bright productivity scenes to limit persistence and improve readability of mid-tones; the reduction can be smoothed over several frames to avoid visible pumping. In gaming scenes with darker palettes, duty reductions can be deeper, with power savings measured in experimentation in representative titles on the order of about 0.12 W to about 0.46 W for the backlight while maintaining scene brightness through compensation. CADC can be implemented in parallel with compositor rendering so that its computation does not add pipeline latency.

In one embodiment, a lightweight statistics buffer of approximately 387×207 pixels, or another reduced resolution appropriate for the panel, is sampled to estimate scene characteristics, and CADC parameters are updated from those estimates while the compositor prepares the next frame. CPU load can be minimal, and GPU cost can be fractionally small per frame because operations are primarily histogramming or average luminance estimation. In variations, CADC weights can be learned or adaptively tuned based on user preference, device thermal state, or measured line-time margins.

In user-adjustable embodiments, CADC exposes a strength parameter that allows end users to tune the degree of duty reduction relative to compensation gains. For users who prefer maximum detail retention in shadow regions, the strength can be reduced so that compensation does not over-boost low luminance, whereas users sensitive to motion blur can increase strength to favor lower persistence. Profiles may be applied per application or scene class and can be overridden by platform policy when an application declares preferred presentation characteristics.

Global white-point offset calibration can be performed to correct thermal-induced color shifts from module conditions, such as approximately 25° C., to typical head-mounted conditions, such as approximately 40° C. In one embodiment, engineering builds and production samples are measured across several hundred units to determine the statistical distribution of white-point drift as a function of temperature and operational state. A global offset is then selected to center the expected distribution on the target white-point, thereby improving color accuracy in both VR rendering and passthrough camera pipelines.

The global offset can be applied per program or per device. In some embodiments, a global offset is used to minimize manufacturing complexity, whereas in premium devices or service modes a per-unit calibration can be used to further reduce color error. Per-unit calibration may be performed at end-of-line test by applying device-specific offsets derived from measured panel behavior and stored in non-volatile memory; runtime calibration can also be supported when sensors detect sustained thermal conditions outside expected ranges. Latency reduction can be achieved through multiple coordinated knobs. In one embodiment, chromatic aberration correction (CAC) is executed on the display processing unit within the system-on-chip so that CAC output feeds directly into panel write without round-tripping to a separate compute stage, reducing the head-pose-to-photon path by approximately one millisecond in representative pipelines. The scheduler bases its refresh-state estimates on the post-CAC timing to align window placement with the actual write completion and to ensure inter-ocular coordination remains accurate.

In another embodiment, the MIPI-DSI link rate is increased during high-motion scenes or when the scheduler predicts tight window budgets. By shortening line times, the system expands the available margin between refresh completion and the next frame boundary, thereby enabling earlier window starts that reduce motion-to-photon latency while still meeting settling criteria. Link-rate adjustments can be gated by thermal headroom, power supply stability, or policy constraints to avoid adverse device impacts.

Display scaling is an optional pipeline adjustment that can influence refresh-state timing and window budgets. In one embodiment, dynamic resolution scaling reduces the number of pixels written per frame under heavy motion or when computational load is high, which shortens effective scan durations and increases time available for emission windows. Although scaling may be deferred or disabled in some programs, it remains a viable alternative knob for balancing latency and artifact reduction without changing the underlying scheduling framework.

Brightness disparity calibration can be performed between regions to equalize perceived brightness across the eyes. In one embodiment, an optical sensor positioned within the optical path measures output from each illumination subsystem during a calibration mode, and the controller trims current or pulse amplitudes to minimize disparity. In another embodiment, disparity is inferred from sensorless metrics such as driver telemetry and historical duty levels, and calibration is applied through PWM duty or current scaling tables. Calibration can be static at manufacture or dynamic during runtime, with safeguards to preserve inter-ocular timing coordination.

The disclosed scheduling, CADC, and calibration techniques generalize across display technologies. In LCOS embodiments, the illumination subsystem can be a projector light source driven with strobed pulses synchronized to shutter or digital micromirror positions; settling models reflect optical and mechanical dynamics rather than liquid-crystal response. In micro-LED or OLED-on-silicon embodiments, the illumination subsystem can be on-panel emissive drivers with segment strobing, and the response model can rely on emissive decay and driver characteristics. While the physics differ, the concepts of per-region refresh-state sensing, operating-condition-aware window placement, and inter-ocular alignment remain applicable. The techniques are compatible with passthrough pipelines and can improve perceived clarity and color fidelity in mixed reality scenarios. For example, CADC can reduce persistence during camera-derived overlays, enhancing edge acuity and readability of UI elements, while the global white-point offset maintains natural color rendering of the real world. Inter-ocular alignment of emissions ensures that passthrough content appears temporally stable across both eyes even when scan directions differ due to panel rotation.

In some embodiments, machine learning models are trained to predict settling intervals or optimal window positions as functions of temperature, voltage, refresh rate, content category, and historical device behavior. These models can replace or augment analytic response curves and can be updated via over-the-air software updates as fleet data accumulates. Regardless of implementation, the scheduler enforces guardrails such as minimum stability intervals and maximum inter-ocular offsets to preserve visual comfort. In yet other embodiments, developer-facing APIs expose configuration parameters, including alignment tolerance, duty floors, compensation gains, and pipeline latency offsets. Applications can declare preferences for motion blur versus brightness, and the scheduler mediates those preferences within device policy constraints. User-facing controls may be provided for CADC strength or color warmth, with safe ranges that maintain artifact suppression and binocular comfort.

Measurements and feedback can be integrated to maintain performance over device lifetime. For instance, as panels age and liquid-crystal or LED response drifts, the system can incrementally increase modeled settling intervals or adjust compensation gains to keep artifacts below perceptual thresholds. Sensor readouts of temperature, supply voltage, and timing drift can be fused into a stability metric that informs window placement. Finally, the disclosed approach can be combined with rendering optimizations such as foveated rendering or gaze-contingent refresh prioritization. When eye tracking is available, the scheduler may bias window placement to regions of interest to reduce latency where visual acuity is highest, while still satisfying inter-ocular alignment globally. Such variations remain consistent with the core concept of determining per-region illumination windows from refresh state and operating conditions and coordinating emission timing to align perception and suppress artifacts.

In conclusion, the disclosed scheduling architecture provides a concrete technical solution to a well-recognized technical problem in near-eye displays: simultaneous suppression of LCD ghosting and reduction of motion-to-photon latency without inducing inter-ocular timing disparity on a single panel. By sensing operating conditions (e.g., temperature), tracking region-specific refresh state, and computing per-region illumination windows that are coordinated for inter-ocular alignment while deferred until stability criteria are met, the system resolves conflicting constraints that prior designs addressed only partially or with dual-panel hardware. The condition-adaptive, per-eye emission control, implemented through independently controllable illumination subsystems, directly improves temporal presentation fidelity, mitigates display-induced motion artifacts, and preserves user comfort during dynamic motion. Optional integrations, including content-adaptive duty and global color offsets, further enhance efficiency and color accuracy without added latency. Collectively, these mechanisms transform raw panel and sensor signals into precise, synchronized illumination timing, yielding measurable improvements in visual fidelity and system responsiveness through a definitively technical approach.

### EXAMPLE EMBODIMENTS

Clause 1. A computer-implemented method comprising: driving a near-eye display including a single image panel partitioned into left- and right-eye regions and respective independently controllable illumination subsystems; sensing an operating condition of the near-eye display; determining, for each of the left- and right-eye regions, an illumination window based at least in part on a refresh state of that region and the operating condition; and commanding the illumination subsystems to emit during the determined illumination windows while coordinating per-region emission timing to satisfy inter-ocular alignment and mitigate display-induced motion artifacts.

Clause 2. The method of clause 1, wherein the operating condition comprises at least temperature.

Clause 3. The method of clause 1, wherein the operating condition comprises at least one of ambient temperature, panel temperature, refresh rate, supply voltage, illumination subsystem temperature, or panel age.

Clause 4. The method of clause 1, wherein the refresh state comprises at least one of a scanout position, a line or row index, a region update completion indicator, or a frame boundary indicator.

Clause 5. The method of clause 1, further comprising: modeling, for each of the left- and right-eye regions, a response characteristic of the image panel as a function of the operating condition, and determining the illumination window based at least in part on a settling time obtained from the model.

Clause 6. The method of clause 1, wherein coordinating the per-region emission timing comprises enforcing an inter-ocular temporal disparity constraint.

Clause 7. The method of clause 6, wherein the inter-ocular temporal disparity constraint comprises a maximum allowable time offset between the illumination windows.

Clause 8. The method of clause 1, wherein the illumination subsystems comprise independently controllable backlights.

Clause 9. The method of clause 1, wherein the illumination subsystems comprise segmented illumination sources that are independently strobed for the left- and right-eye regions.

Clause 10. The method of clause 1, wherein the illumination windows overlap in time.

Clause 11. The method of clause 1, further comprising content-adaptively modulating an illumination duty within at least one illumination window.

Clause 12. The method of clause 11, further comprising compensating perceived brightness responsive to duty modulation by adjusting effective luminance via at least one of pixel drive or illumination amplitude.

Clause 13. The method of clause 1, further comprising sensing a motion state of the near-eye display or a user head pose and, based at least in part on the motion state, adjusting the per-region emission timing.

Clause 14. The method of clause 1, wherein sensing the operating condition comprises reading at least one temperature sensor coupled to the image panel or an illumination subsystem.

Clause 15. The method of clause 1, further comprising reducing motion-to-photon latency by advancing at least one illumination window while maintaining the inter-ocular alignment.

Clause 16. The method of clause 1, further comprising adjusting a data link rate or pipeline scheduling to align the refresh state with the coordinated emission timing.

Clause 17. The method of clause 1, further comprising performing chromatic aberration correction and coordinating the per-region emission timing to account for processing latency.

Clause 18. The method of clause 1, wherein the single image panel is rotated relative to an optical axis such that the refresh state of the left- and right-eye regions progresses in opposite directions.

Clause 19. A system comprising: at least one physical processor; physical memory comprising computer-executable instructions that, when executed by the physical processor, cause the physical processor to: drive a near-eye display including a single image panel partitioned into left- and right-eye regions and respective independently controllable illumination subsystems; sense an operating condition of the near-eye display; determine, for each region, an illumination window based at least in part on a refresh state of that region and the operating condition; and command the illumination subsystems to emit during the determined illumination windows while coordinating per-region emission timing to satisfy inter-ocular alignment and mitigate display-induced motion artifacts.

Clause 20. A non-transitory computer-readable medium comprising one or more computer-executable instructions that, when executed by at least one processor of a computing device, cause the computing device to: drive a near-eye display including a single image panel partitioned into left- and right-eye regions and respective independently controllable illumination subsystems; sense an operating condition of the near-eye display; determine, for each region, an illumination window based at least in part on a refresh state of that region and the operating condition; and command the illumination subsystems to emit during the determined illumination windows while coordinating per-region emission timing to satisfy inter-ocular alignment and mitigate display-induced motion artifacts.

Embodiments of the present disclosure may include or be implemented in conjunction with various types of Artificial-Reality (AR) systems. AR may be any superimposed functionality and/or sensory-detectable content presented by an artificial-reality system within a user's physical surroundings. In other words, AR is a form of reality that has been adjusted in some manner before presentation to a user. AR can include and/or represent virtual reality (VR), augmented reality, mixed AR (MAR), or some combination and/or variation of these types of realities. Similarly, AR environments may include VR environments (including non-immersive, semi-immersive, and fully immersive VR environments), augmented-reality environments (including marker-based augmented-reality environments, markerless augmented-reality environments, location-based augmented-reality environments, and projection-based augmented-reality environments), hybrid-reality environments, and/or any other type or form of mixed- or alternative-reality environments.

AR content may include completely computer-generated content or computer-generated content combined with captured (e.g., real-world) content. Such AR content may include video, audio, haptic feedback, or some combination thereof, any of which may be presented in a single channel or in multiple channels (such as stereo video that produces a three-dimensional (3D) effect to the viewer). Additionally, in some embodiments, AR may also be associated with applications, products, accessories, services, or some combination thereof, that are used to, for example, create content in an artificial reality and/or are otherwise used in (e.g., to perform activities in) an artificial reality.

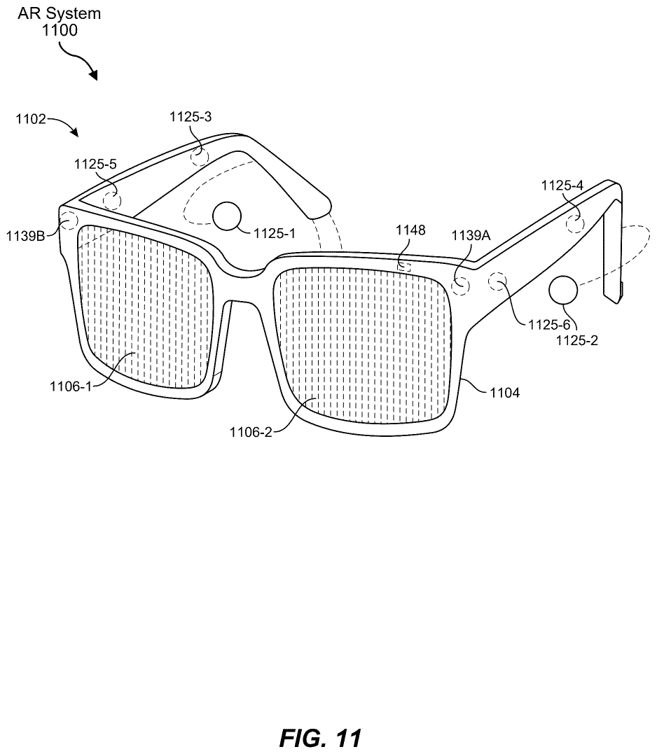

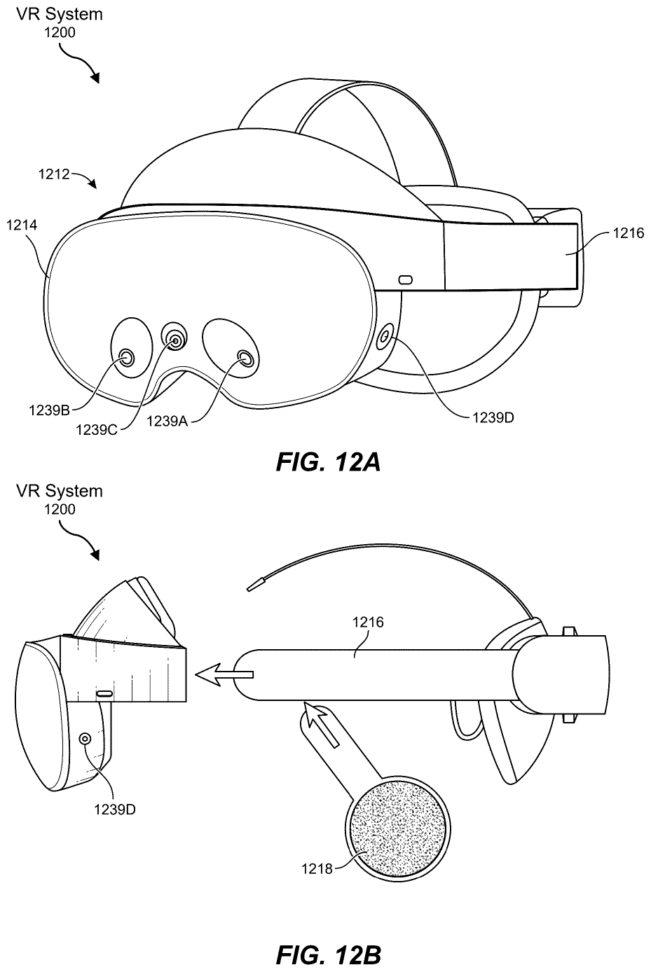

AR systems may be implemented in a variety of different form factors and configurations. Some AR systems may be designed to work without near-eye displays (NEDs). Other AR systems may include a NED that also provides visibility into the real world (such as, e.g., augmented-reality system 1100 in FIG. 11) or that visually immerses a user in an artificial reality (such as, e.g., virtual-reality system 1200 in FIGS. 12A and 12B). While some AR devices may be self-contained systems, other AR devices may communicate and/or coordinate with external devices to provide an AR experience to a user. Examples of such external devices include handheld controllers, mobile devices, desktop computers, devices worn by a user, devices worn by one or more other users, and/or any other suitable external system.

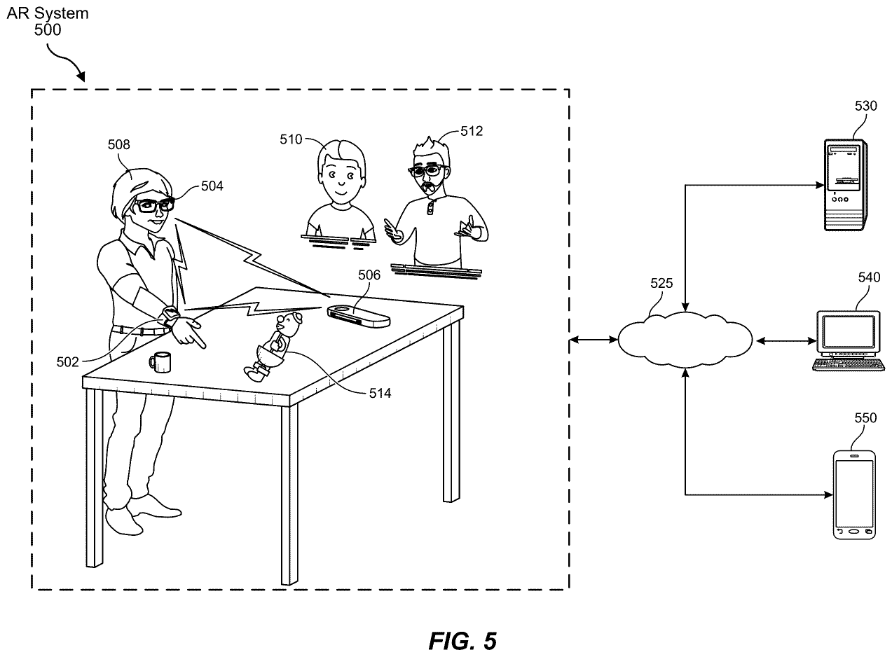

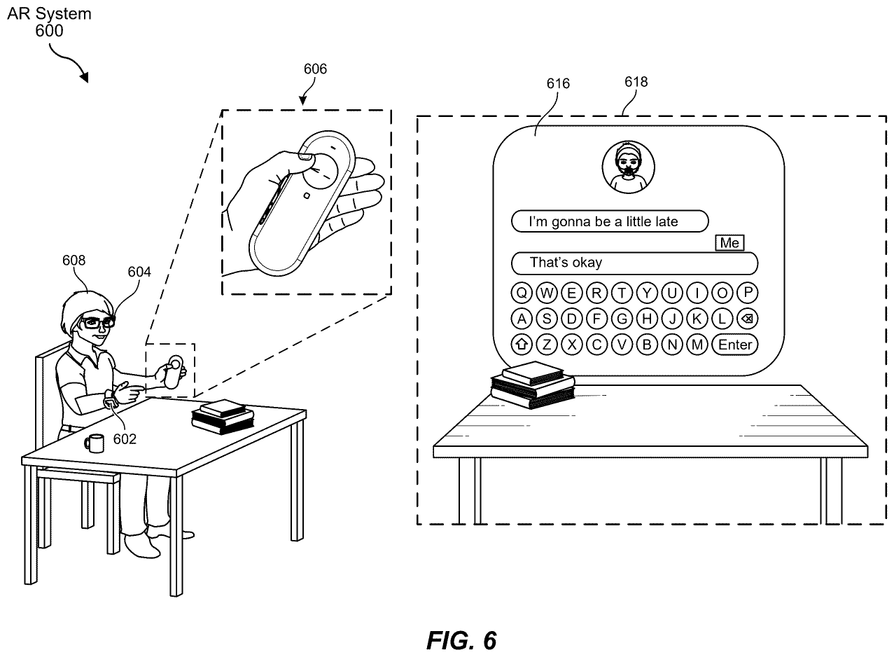

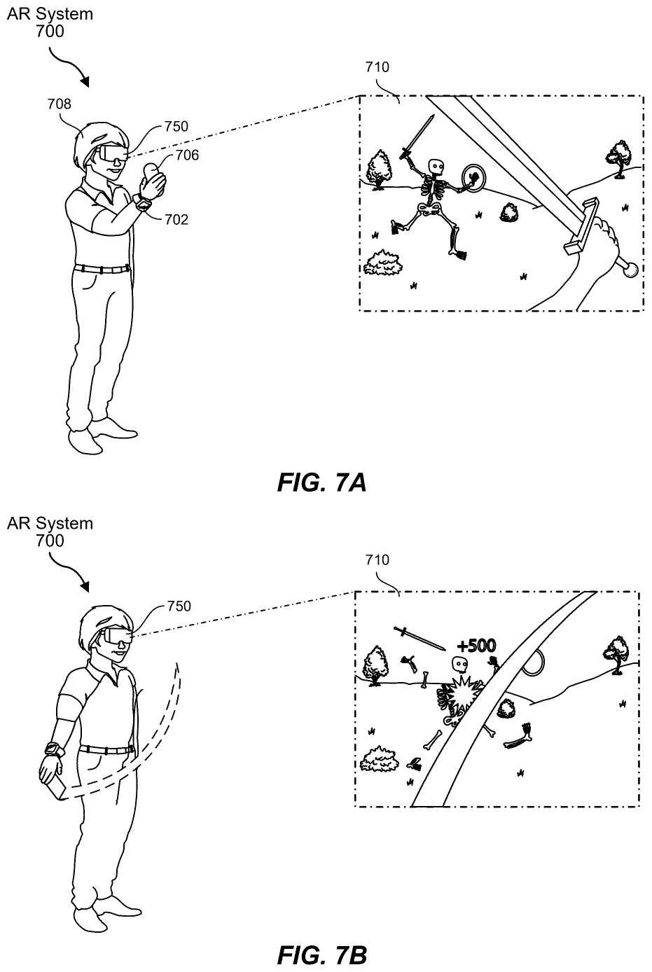

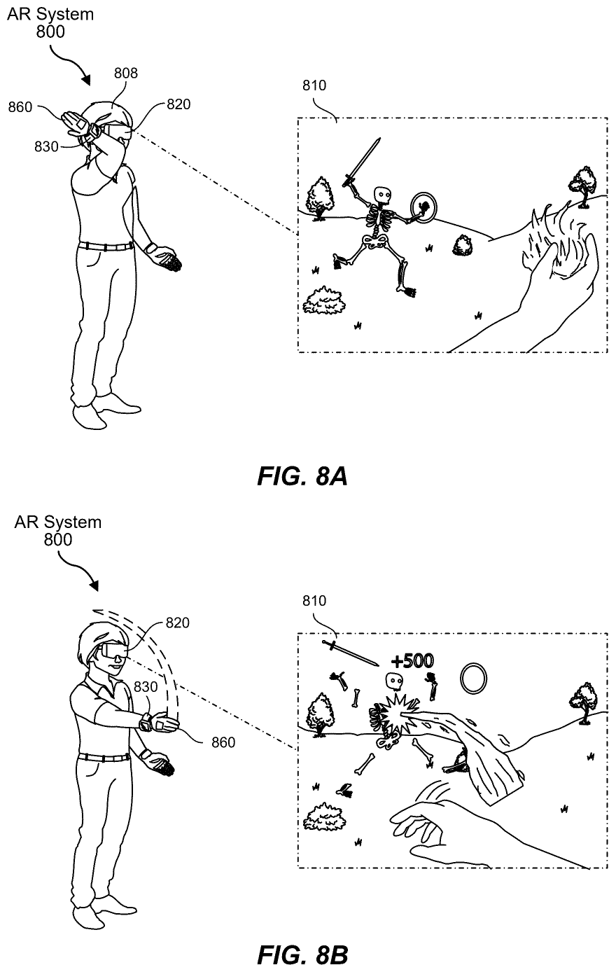

FIGS. 5-8B illustrate example artificial-reality (AR) systems in accordance with some embodiments. FIG. 5 shows a first AR system 500 and first example user interactions using a wrist-wearable device 502, a head-wearable device (e.g., AR glasses 1100), and/or a handheld intermediary processing device (HIPD) 506. FIG. 6 shows a second AR system 600 and second example user interactions using a wrist-wearable device 602, AR glasses 604, and/or an HIPD 606. FIGS. 7A and 7B show a third AR system 700 and third example user 708 interactions using a wrist-wearable device 702, a head-wearable device (e.g., VR headset 750), and/or an HIPD 706. FIGS. 8A and 8B show a fourth AR system 800 and fourth example user 808 interactions using a wrist-wearable device 830, VR headset 820, and/or a haptic device 860 (e.g., wearable gloves).

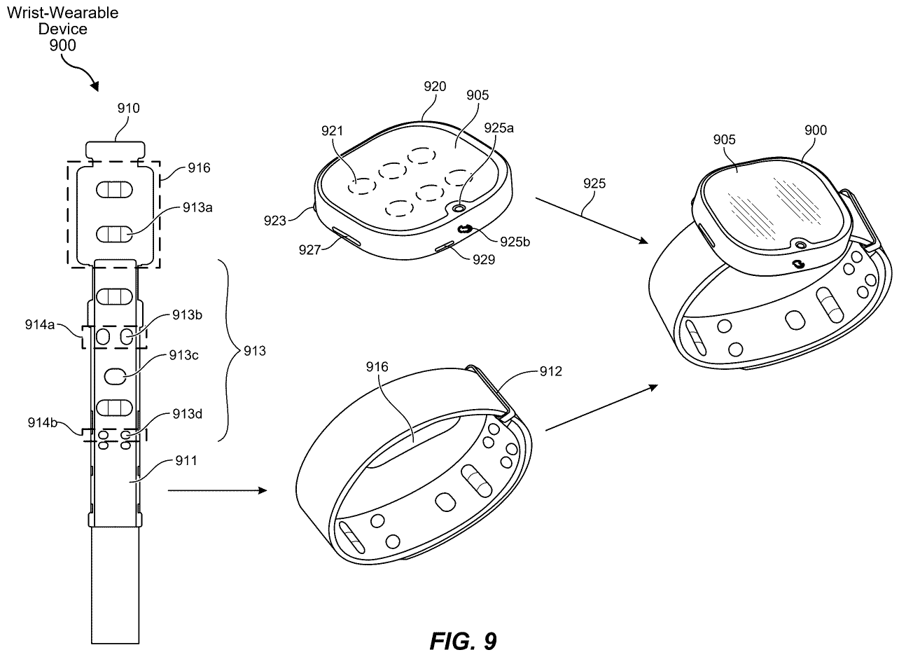

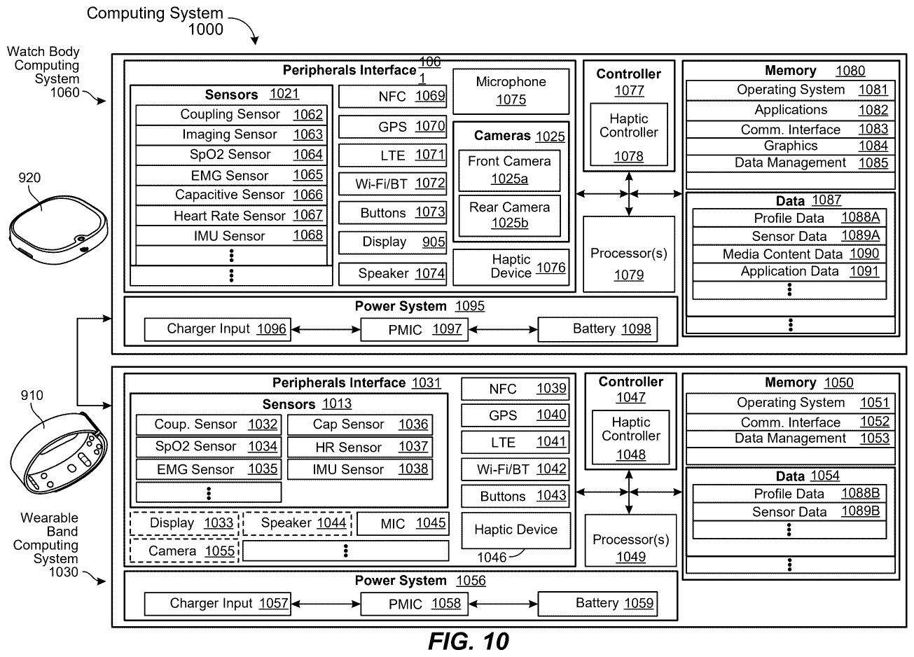

A wrist-wearable device 900, which can be used for wrist-wearable device 502, 602, 702, 830, and one or more of its components, are described below in reference to FIGS. 9 and 10; head-wearable devices 1100 and 1200, which can respectively be used for AR glasses 504, 604 or VR headset 750, 820, and their one or more components are described below in reference to FIGS. 11-13.

Referring to FIG. 5, wrist-wearable device 502, AR glasses 504, and/or HIPD 506 can communicatively couple via a network 525 (e.g., cellular, near field, Wi-Fi, personal area network, wireless LAN, etc.). Additionally, wrist-wearable device 502, AR glasses 504, and/or HIPD 506 can also communicatively couple with one or more servers 530, computers 540 (e.g., laptops, computers, etc.), mobile devices 550 (e.g., smartphones, tablets, etc.), and/or other electronic devices via network 525 (e.g., cellular, near field, Wi-Fi, personal area network, wireless LAN, etc.).

In FIG. 5, a user 508 is shown wearing wrist-wearable device 502 and AR glasses 504 and having HIPD 506 on their desk. The wrist-wearable device 502, AR glasses 504, and HIPD 506 facilitate user interaction with an AR environment. In particular, as shown by first AR system 500, wrist-wearable device 502, AR glasses 504, and/or HIPD 506 cause presentation of one or more avatars 510, digital representations of contacts 512, and virtual objects 514. As discussed below, user 508 can interact with one or more avatars 510, digital representations of contacts 512, and virtual objects 514 via wrist-wearable device 502, AR glasses 504, and/or HIPD 506.

User 508 can use any of wrist-wearable device 502, AR glasses 504, and/or HIPD 506 to provide user inputs. For example, user 508 can perform one or more hand gestures that are detected by wrist-wearable device 502 (e.g., using one or more EMG sensors and/or IMUs, described below in reference to FIGS. 9 and 10) and/or AR glasses 504 (e.g., using one or more image sensor or camera, described below in reference to FIGS. 11-10) to provide a user input. Alternatively, or additionally, user 508 can provide a user input via one or more touch surfaces of wrist-wearable device 502, AR glasses 504, HIPD 506, and/or voice commands captured by a microphone of wrist-wearable device 502, AR glasses 504, and/or HIPD 506. In some embodiments, wrist-wearable device 502, AR glasses 504, and/or HIPD 506 include a digital assistant to help user 508 in providing a user input (e.g., completing a sequence of operations, suggesting different operations or commands, providing reminders, confirming a command, etc.). In some embodiments, user 508 can provide a user input via one or more facial gestures and/or facial expressions. For example, cameras of wrist-wearable device 502, AR glasses 504, and/or HIPD 506 can track eyes of user 508 for navigating a user interface.

Wrist-wearable device 502, AR glasses 504, and/or HIPD 506 can operate alone or in conjunction to allow user 508 to interact with the AR environment. In some embodiments, HIPD 506 is configured to operate as a central hub or control center for the wrist-wearable device 502, AR glasses 504, and/or another communicatively coupled device. For example, user 508 can provide an input to interact with the AR environment at any of wrist-wearable device 502, AR glasses 504, and/or HIPD 506, and HIPD 506 can identify one or more back-end and front-end tasks to cause the performance of the requested interaction and distribute instructions to cause the performance of the one or more back-end and front-end tasks at wrist-wearable device 502, AR glasses 504, and/or HIPD 506. In some embodiments, a back-end task is a background processing task that is not perceptible by the user (e.g., rendering content, decompression, compression, etc.), and a front-end task is a user-facing task that is perceptible to the user (e.g., presenting information to the user, providing feedback to the user, etc.). As described below, HIPD 506 can perform the back-end tasks and provide wrist-wearable device 502 and/or AR glasses 504 operational data corresponding to the performed back-end tasks such that wrist-wearable device 502 and/or AR glasses 504 can perform the front-end tasks. In this way, HIPD 506, which has more computational resources and greater thermal headroom than wrist-wearable device 502 and/or AR glasses 504, performs computationally intensive tasks and reduces the computer resource utilization and/or power usage of wrist-wearable device 502 and/or AR glasses 504.

In the example shown by first AR system 500, HIPD 506 identifies one or more back-end tasks and front-end tasks associated with a user request to initiate an AR video call with one or more other users (represented by avatar 510 and the digital representation of contact 512) and distributes instructions to cause the performance of the one or more back-end tasks and front-end tasks. In particular, HIPD 506 performs back-end tasks for processing and/or rendering image data (and other data) associated with the AR video call and provides operational data associated with the performed back-end tasks to AR glasses 504 such that the AR glasses 504 perform front-end tasks for presenting the AR video call (e.g., presenting avatar 510 and digital representation of contact 512).

In some embodiments, HIPD 506 can operate as a focal or anchor point for causing the presentation of information. This allows user 508 to be generally aware of where information is presented. For example, as shown in first AR system 500, avatar 510 and the digital representation of contact 512 are presented above HIPD 506. In particular, HIPD 506 and AR glasses 504 operate in conjunction to determine a location for presenting avatar 510 and the digital representation of contact 512. In some embodiments, information can be presented a predetermined distance from HIPD 506 (e.g., within 5 meters). For example, as shown in first AR system 500, virtual object 514 is presented on the desk some distance from HIPD 506. Similar to the above example, HIPD 506 and AR glasses 504 can operate in conjunction to determine a location for presenting virtual object 514. Alternatively, in some embodiments, presentation of information is not bound by HIPD 506. More specifically, avatar 510, digital representation of contact 512, and virtual object 514 do not have to be presented within a predetermined distance of HIPD 506.

User inputs provided at wrist-wearable device 502, AR glasses 504, and/or HIPD 506 are coordinated such that the user can use any device to initiate, continue, and/or complete an operation. For example, user 508 can provide a user input to AR glasses 504 to cause AR glasses 504 to present virtual object 514 and, while virtual object 514 is presented by AR glasses 504, user 508 can provide one or more hand gestures via wrist-wearable device 502 to interact and/or manipulate virtual object 514.

FIG. 6 shows a user 608 wearing a wrist-wearable device 602 and AR glasses 604, and holding an HIPD 606. In second AR system 600, the wrist-wearable device 602, AR glasses 604, and/or HIPD 606 are used to receive and/or provide one or more messages to a contact of user 608. In particular, wrist-wearable device 602, AR glasses 604, and/or HIPD 606 detect and coordinate one or more user inputs to initiate a messaging application and prepare a response to a received message via the messaging application.

In some embodiments, user 608 initiates, via a user input, an application on wrist-wearable device 602, AR glasses 604, and/or HIPD 606 that causes the application to initiate on at least one device. For example, in second AR system 600, user 608 performs a hand gesture associated with a command for initiating a messaging application (represented by messaging user interface 616), wrist-wearable device 602 detects the hand gesture and, based on a determination that user 608 is wearing AR glasses 604, causes AR glasses 604 to present a messaging user interface 616 of the messaging application. AR glasses 604 can present messaging user interface 616 to user 608 via its display (e.g., as shown by a field of view 618 of user 608). In some embodiments, the application is initiated and executed on the device (e.g., wrist-wearable device 602, AR glasses 604, and/or HIPD 606) that detects the user input to initiate the application, and the device provides another device operational data to cause the presentation of the messaging application. For example, wrist-wearable device 602 can detect the user input to initiate a messaging application, initiate and run the messaging application, and provide operational data to AR glasses 604 and/or HIPD 606 to cause presentation of the messaging application. Alternatively, the application can be initiated and executed at a device other than the device that detected the user input. For example, wrist-wearable device 602 can detect the hand gesture associated with initiating the messaging application and cause HIPD 606 to run the messaging application and coordinate the presentation of the messaging application.

Further, user 608 can provide a user input provided at wrist-wearable device 602, AR glasses 604, and/or HIPD 606 to continue and/or complete an operation initiated at another device. For example, after initiating the messaging application via wrist-wearable device 602 and while AR glasses 604 present messaging user interface 616, user 608 can provide an input at HIPD 606 to prepare a response (e.g., shown by the swipe gesture performed on HIPD 606). Gestures performed by user 608 on HIPD 606 can be provided and/or displayed on another device. For example, a swipe gestured performed on HIPD 606 is displayed on a virtual keyboard of messaging user interface 616 displayed by AR glasses 604.

In some embodiments, wrist-wearable device 602, AR glasses 604, HIPD 606, and/or any other communicatively coupled device can present one or more notifications to user 608. The notification can be an indication of a new message, an incoming call, an application update, a status update, etc. User 608 can select the notification via wrist-wearable device 602, AR glasses 604, and/or HIPD 606 and can cause presentation of an application or operation associated with the notification on at least one device. For example, user 608 can receive a notification that a message was received at wrist-wearable device 602, AR glasses 604, HIPD 606, and/or any other communicatively coupled device and can then provide a user input at wrist-wearable device 602, AR glasses 604, and/or HIPD 606 to review the notification, and the device detecting the user input can cause an application associated with the notification to be initiated and/or presented at wrist-wearable device 602, AR glasses 604, and/or HIPD 606.

While the above example describes coordinated inputs used to interact with a messaging application, user inputs can be coordinated to interact with any number of applications including, but not limited to, gaming applications, social media applications, camera applications, web-based applications, financial applications, etc. For example, AR glasses 604 can present to user 608 game application data, and HIPD 606 can be used as a controller to provide inputs to the game. Similarly, user 608 can use wrist-wearable device 602 to initiate a camera of AR glasses 604, and user 608 can use wrist-wearable device 602, AR glasses 604, and/or HIPD 606 to manipulate the image capture (e.g., zoom in or out, apply filters, etc.) and capture image data.

Users may interact with the devices disclosed herein in a variety of ways. For example, as shown in FIGS. 7A and 7B, a user 708 may interact with an AR system 700 by donning a VR headset 750 while holding HIPD 706 and wearing wrist-wearable device 702. In this example, AR system 700 may enable a user to interact with a game 710 by swiping their arm. One or more of VR headset 750, HIPD 706, and wrist-wearable device 702 may detect this gesture and, in response, may display a sword strike in game 710. Similarly, in FIGS. 8A and 8B, a user 808 may interact with an AR system 800 by donning a VR headset 820 while wearing haptic device 860 and wrist-wearable device 830. In this example, AR system 800 may enable a user to interact with a game 810 by swiping their arm. One or more of VR headset 820, haptic device 860, and wrist-wearable device 830 may detect this gesture and, in response, may display a spell being cast in game 710.

Having discussed example AR systems, devices for interacting with such AR systems and other computing systems more generally will now be discussed in greater detail. Some explanations of devices and components that can be included in some or all of the example devices discussed below are explained herein for ease of reference. Certain types of the components described below may be more suitable for a particular set of devices, and less suitable for a different set of devices. But subsequent reference to the components explained here should be considered to be encompassed by the descriptions provided.

In some embodiments discussed below, example devices and systems, including electronic devices and systems, will be addressed. Such example devices and systems are not intended to be limiting, and one of skill in the art will understand that alternative devices and systems to the example devices and systems described herein may be used to perform the operations and construct the systems and devices that are described herein.

An electronic device may be a device that uses electrical energy to perform a specific function. An electronic device can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device may be a device that sits between two other electronic devices and/or a subset of components of one or more electronic devices and facilitates communication, data processing, and/or data transfer between the respective electronic devices and/or electronic components.

An integrated circuit may be an electronic device made up of multiple interconnected electronic components such as transistors, resistors, and capacitors. These components may be etched onto a small piece of semiconductor material, such as silicon. Integrated circuits may include analog integrated circuits, digital integrated circuits, mixed signal integrated circuits, and/or any other suitable type or form of integrated circuit. Examples of integrated circuits include application-specific integrated circuits (ASICs), processing units, central processing units (CPUs), co-processors, and accelerators.

Analog integrated circuits, such as sensors, power management circuits, and operational amplifiers, may process continuous signals and perform analog functions such as amplification, active filtering, demodulation, and mixing. Examples of analog integrated circuits include linear integrated circuits and radio frequency circuits.

Digital integrated circuits, which may be referred to as logic integrated circuits, may include microprocessors, microcontrollers, memory chips, interfaces, power management circuits, programmable devices, and/or any other suitable type or form of integrated circuit. In some embodiments, examples of integrated circuits include central processing units (CPUs),

Processing units, such as CPUs, may be electronic components that are responsible for executing instructions and controlling the operation of an electronic device (e.g., a computer). There are various types of processors that may be used interchangeably, or may be specifically required, by embodiments described herein. For example, a processor may be: (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) an accelerator, such as a graphics processing unit (GPU), designed to accelerate the creation and rendering of images, videos, and animations (e.g., virtual-reality animations, such as three-dimensional modeling); (iv) a field-programmable gate array (FPGA) that can be programmed and reconfigured after manufacturing and/or can be customized to perform specific tasks, such as signal processing, cryptography, and machine learning; and/or (v) a digital signal processor (DSP) designed to perform mathematical operations on signals such as audio, video, and radio waves. One or more processors of one or more electronic devices may be used in various embodiments described herein.

Memory generally refers to electronic components in a computer or electronic device that store data and instructions for the processor to access and manipulate. Examples of memory can include: (i) random access memory (RAM) configured to store data and instructions temporarily; (ii) read-only memory (ROM) configured to store data and instructions permanently (e.g., one or more portions of system firmware, and/or boot loaders) and/or semi-permanently; (iii) flash memory, which can be configured to store data in electronic devices (e.g., USB drives, memory cards, and/or solid-state drives (SSDs)); and/or (iv) cache memory configured to temporarily store frequently accessed data and instructions. Memory, as described herein, can store structured data (e.g., SQL databases, MongoDB databases, GraphQL data, JSON data, etc.). Other examples of data stored in memory can include (i) profile data, including user account data, user settings, and/or other user data stored by the user, (ii) sensor data detected and/or otherwise obtained by one or more sensors, (iii) media content data including stored image data, audio data, documents, and the like, (iv) application data, which can include data collected and/or otherwise obtained and stored during use of an application, and/or any other types of data described herein.

Controllers may be electronic components that manage and coordinate the operation of other components within an electronic device (e.g., controlling inputs, processing data, and/or generating outputs). Examples of controllers can include: (i) microcontrollers, including small, low-power controllers that are commonly used in embedded systems and Internet of Things (IOT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or (iv) DSPs.

A power system of an electronic device may be configured to convert incoming electrical power into a form that can be used to operate the device. A power system can include various components, such as (i) a power source, which can be an alternating current (AC) adapter or a direct current (DC) adapter power supply, (ii) a charger input, which can be configured to use a wired and/or wireless connection (which may be part of a peripheral interface, such as a USB, micro-USB interface, near-field magnetic coupling, magnetic inductive and magnetic resonance charging, and/or radio frequency (RF) charging), (iii) a power-management integrated circuit, configured to distribute power to various components of the device and to ensure that the device operates within safe limits (e.g., regulating voltage, controlling current flow, and/or managing heat dissipation), and/or (iv) a battery configured to store power to provide usable power to components of one or more electronic devices.

Peripheral interfaces may be electronic components (e.g., of electronic devices) that allow electronic devices to communicate with other devices or peripherals and can provide the ability to input and output data and signals. Examples of peripheral interfaces can include (i) universal serial bus (USB) and/or micro-USB interfaces configured for connecting devices to an electronic device, (ii) Bluetooth interfaces configured to allow devices to communicate with each other, including Bluetooth low energy (BLE), (iii) near field communication (NFC) interfaces configured to be short-range wireless interfaces for operations such as access control, (iv) POGO pins, which may be small, spring-loaded pins configured to provide a charging interface, (v) wireless charging interfaces, (vi) GPS interfaces, (vii) Wi-Fi interfaces for providing a connection between a device and a wireless network, and/or (viii) sensor interfaces.

Sensors may be electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device), (ii) biopotential-signal sensors, (iii) inertial measurement units (e.g., IMUs) for detecting, for example, angular rate, force, magnetic field, and/or changes in acceleration, (iv) heart rate sensors for measuring a user's heart rate, (v) SpO2 sensors for measuring blood oxygen saturation and/or other biometric data of a user, (vi) capacitive sensors for detecting changes in potential at a portion of a user's body (e.g., a sensor-skin interface), and/or (vii) light sensors (e.g., time-of-flight sensors, infrared light sensors, visible light sensors, etc.).

Biopotential-signal-sensing components may be devices used to measure electrical activity within the body (e.g., biopotential-signal sensors). Some types of biopotential-signal sensors include (i) electroencephalography (EEG) sensors configured to measure electrical activity in the brain to diagnose neurological disorders, (ii) electrocardiography (ECG or EKG) sensors configured to measure electrical activity of the heart to diagnose heart problems, (iii) electromyography (EMG) sensors configured to measure the electrical activity of muscles and to diagnose neuromuscular disorders, and (iv) electrooculography (EOG) sensors configure to measure the electrical activity of eye muscles to detect eye movement and diagnose eye disorders.

An application stored in memory of an electronic device (e.g., software) may include instructions stored in the memory. Examples of such applications include (i) games, (ii) word processors, (iii) messaging applications, (iv) media-streaming applications, (v) financial applications, (vi) calendars. (vii) clocks, and (viii) communication interface modules for enabling wired and/or wireless connections between different respective electronic devices (e.g., IEEE 1102.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocols).

A communication interface may be a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, Bluetooth). In some embodiments, a communication interface can refer to a software layer that enables different software programs to communicate with each other (e.g., application programming interfaces (APIs), protocols like HTTP and TCP/IP, etc.).

A graphics module may be a component or software module that is designed to handle graphical operations and/or processes and can include a hardware module and/or a software module.

Non-transitory computer-readable storage media may be physical devices or storage media that can be used to store electronic data in a non-transitory form (e.g., such that the data is stored permanently until it is intentionally deleted or modified).

FIGS. 9 and 10 illustrate an example wrist-wearable device 900 and an example computer system 1000, in accordance with some embodiments. Wrist-wearable device 900 is an instance of wearable device 502 described in FIG. 5 herein, such that the wearable device 502 should be understood to have the features of the wrist-wearable device 900 and vice versa. FIG. 10 illustrates components of the wrist-wearable device 900, which can be used individually or in combination, including combinations that include other electronic devices and/or electronic components.

FIG. 9 shows a wearable band 910 and a watch body 920 (or capsule) being coupled, as discussed below, to form wrist-wearable device 900. Wrist-wearable device 900 can perform various functions and/or operations associated with navigating through user interfaces and selectively opening applications as well as the functions and/or operations described above with reference to FIGS. 5-8B.

As will be described in more detail below, operations executed by wrist-wearable device 900 can include (i) presenting content to a user (e.g., displaying visual content via a display 905), (ii) detecting (e.g., sensing) user input (e.g., sensing a touch on peripheral button 923 and/or at a touch screen of the display 905, a hand gesture detected by sensors (e.g., biopotential sensors)), (iii) sensing biometric data (e.g., neuromuscular signals, heart rate, temperature, sleep, etc.) via one or more sensors 913, messaging (e.g., text, speech, video, etc.); image capture via one or more imaging devices or cameras 925, wireless communications (e.g., cellular, near field, Wi-Fi, personal area network, etc.), location determination, financial transactions, providing haptic feedback, providing alarms, providing notifications, providing biometric authentication, providing health monitoring, providing sleep monitoring, etc.

The above-example functions can be executed independently in watch body 920, independently in wearable band 910, and/or via an electronic communication between watch body 920 and wearable band 910. In some embodiments, functions can be executed on wrist-wearable device 900 while an AR environment is being presented (e.g., via one of AR systems 500 to 800). The wearable devices described herein can also be used with other types of AR environments.

Wearable band 910 can be configured to be worn by a user such that an inner surface of a wearable structure 911 of wearable band 910 is in contact with the user's skin. In this example, when worn by a user, sensors 913 may contact the user's skin. In some examples, one or more of sensors 913 can sense biometric data such as a user's heart rate, a saturated oxygen level, temperature, sweat level, neuromuscular signals, or a combination thereof. One or more of sensors 913 can also sense data about a user's environment including a user's motion, altitude, location, orientation, gait, acceleration, position, or a combination thereof. In some embodiment, one or more of sensors 913 can be configured to track a position and/or motion of wearable band 910. One or more of sensors 913 can include any of the sensors defined above and/or discussed below with respect to FIG. 9.

One or more of sensors 913 can be distributed on an inside and/or an outside surface of wearable band 910. In some embodiments, one or more of sensors 913 are uniformly spaced along wearable band 910. Alternatively, in some embodiments, one or more of sensors 913 are positioned at distinct points along wearable band 910. As shown in FIG. 9, one or more of sensors 913 can be the same or distinct. For example, in some embodiments, one or more of sensors 913 can be shaped as a pill (e.g., sensor 913a), an oval, a circle a square, an oblong (e.g., sensor 913c) and/or any other shape that maintains contact with the user's skin (e.g., such that neuromuscular signal and/or other biometric data can be accurately measured at the user's skin). In some embodiments, one or more sensors of 913 are aligned to form pairs of sensors (e.g., for sensing neuromuscular signals based on differential sensing within each respective sensor). For example, sensor 913b may be aligned with an adjacent sensor to form sensor pair 914a and sensor 913d may be aligned with an adjacent sensor to form sensor pair 914b. In some embodiments, wearable band 910 does not have a sensor pair. Alternatively, in some embodiments, wearable band 910 has a predetermined number of sensor pairs (one pair of sensors, three pairs of sensors, four pairs of sensors, six pairs of sensors, sixteen pairs of sensors, etc.).

Wearable band 910 can include any suitable number of sensors 913. In some embodiments, the number and arrangement of sensors 913 depends on the particular application for which wearable band 910 is used. For instance, wearable band 910 can be configured as an armband, wristband, or chest-band that include a plurality of sensors 913 with different number of sensors 913, a variety of types of individual sensors with the plurality of sensors 913, and different arrangements for each use case, such as medical use cases as compared to gaming or general day-to-day use cases.

In accordance with some embodiments, wearable band 910 further includes an electrical ground electrode and a shielding electrode. The electrical ground and shielding electrodes, like the sensors 913, can be distributed on the inside surface of the wearable band 910 such that they contact a portion of the user's skin. For example, the electrical ground and shielding electrodes can be at an inside surface of a coupling mechanism 916 or an inside surface of a wearable structure 911. The electrical ground and shielding electrodes can be formed and/or use the same components as sensors 913. In some embodiments, wearable band 910 includes more than one electrical ground electrode and more than one shielding electrode.

Sensors 913 can be formed as part of wearable structure 911 of wearable band 910. In some embodiments, sensors 913 are flush or substantially flush with wearable structure 911 such that they do not extend beyond the surface of wearable structure 911. While flush with wearable structure 911, sensors 913 are still configured to contact the user's skin (e.g., via a skin-contacting surface). Alternatively, in some embodiments, sensors 913 extend beyond wearable structure 911 a predetermined distance (e.g., 0.1-2 mm) to make contact and depress into the user's skin. In some embodiment, sensors 913 are coupled to an actuator (not shown) configured to adjust an extension height (e.g., a distance from the surface of wearable structure 911) of sensors 913 such that sensors 913 make contact and depress into the user's skin. In some embodiments, the actuators adjust the extension height between 0.01 mm-1.2 mm. This may allow a the user to customize the positioning of sensors 913 to improve the overall comfort of the wearable band 910 when worn while still allowing sensors 913 to contact the user's skin. In some embodiments, sensors 913 are indistinguishable from wearable structure 911 when worn by the user.

Wearable structure 911 can be formed of an elastic material, elastomers, etc., configured to be stretched and fitted to be worn by the user. In some embodiments, wearable structure 911 is a textile or woven fabric. As described above, sensors 913 can be formed as part of a wearable structure 911. For example, sensors 913 can be molded into the wearable structure 911, be integrated into a woven fabric (e.g., sensors 913 can be sewn into the fabric and mimic the pliability of fabric and can and/or be constructed from a series woven strands of fabric).

Wearable structure 911 can include flexible electronic connectors that interconnect sensors 913, the electronic circuitry, and/or other electronic components (described below in reference to FIG. 10) that are enclosed in wearable band 910. In some embodiments, the flexible electronic connectors are configured to interconnect sensors 913, the electronic circuitry, and/or other electronic components of wearable band 910 with respective sensors and/or other electronic components of another electronic device (e.g., watch body 920). The flexible electronic connectors are configured to move with wearable structure 911 such that the user adjustment to wearable structure 911 (e.g., resizing, pulling, folding, etc.) does not stress or strain the electrical coupling of components of wearable band 910.

As described above, wearable band 910 is configured to be worn by a user. In particular, wearable band 910 can be shaped or otherwise manipulated to be worn by a user. For example, wearable band 910 can be shaped to have a substantially circular shape such that it can be configured to be worn on the user's lower arm or wrist. Alternatively, wearable band 910 can be shaped to be worn on another body part of the user, such as the user's upper arm (e.g., around a bicep), forearm, chest, legs, etc. Wearable band 910 can include a retaining mechanism 912 (e.g., a buckle, a hook and loop fastener, etc.) for securing wearable band 910 to the user's wrist or other body part. While wearable band 910 is worn by the user, sensors 913 sense data (referred to as sensor data) from the user's skin. In some examples, sensors 913 of wearable band 910 obtain (e.g., sense and record) neuromuscular signals.

The sensed data (e.g., sensed neuromuscular signals) can be used to detect and/or determine the user's intention to perform certain motor actions. In some examples, sensors 913 may sense and record neuromuscular signals from the user as the user performs muscular activations (e.g., movements, gestures, etc.). The detected and/or determined motor actions (e.g., phalange (or digit) movements, wrist movements, hand movements, and/or other muscle intentions) can be used to determine control commands or control information (instructions to perform certain commands after the data is sensed) for causing a computing device to perform one or more input commands. For example, the sensed neuromuscular signals can be used to control certain user interfaces displayed on display 905 of wrist-wearable device 900 and/or can be transmitted to a device responsible for rendering an artificial-reality environment (e.g., a head-mounted display) to perform an action in an associated artificial-reality environment, such as to control the motion of a virtual device displayed to the user. The muscular activations performed by the user can include static gestures, such as placing the user's hand palm down on a table, dynamic gestures, such as grasping a physical or virtual object, and covert gestures that are imperceptible to another person, such as slightly tensing a joint by co-contracting opposing muscles or using sub-muscular activations. The muscular activations performed by the user can include symbolic gestures (e.g., gestures mapped to other gestures, interactions, or commands, for example, based on a gesture vocabulary that specifies the mapping of gestures to commands).

The sensor data sensed by sensors 913 can be used to provide a user with an enhanced interaction with a physical object (e.g., devices communicatively coupled with wearable band 910) and/or a virtual object in an artificial-reality application generated by an artificial-reality system (e.g., user interface objects presented on the display 905, or another computing device (e.g., a smartphone)).

In some embodiments, wearable band 910 includes one or more haptic devices 1046 (e.g., a vibratory haptic actuator) that are configured to provide haptic feedback (e.g., a cutaneous and/or kinesthetic sensation, etc.) to the user's skin. Sensors 913 and/or haptic devices 1046 (shown in FIG. 10) can be configured to operate in conjunction with multiple applications including, without limitation, health monitoring, social media, games, and artificial reality (e.g., the applications associated with artificial reality).

Wearable band 910 can also include coupling mechanism 916 for detachably coupling a capsule (e.g., a computing unit) or watch body 920 (via a coupling surface of the watch body 920) to wearable band 910. For example, a cradle or a shape of coupling mechanism 916 can correspond to shape of watch body 920 of wrist-wearable device 900. In particular, coupling mechanism 916 can be configured to receive a coupling surface proximate to the bottom side of watch body 920 (e.g., a side opposite to a front side of watch body 920 where display 905 is located), such that a user can push watch body 920 downward into coupling mechanism 916 to attach watch body 920 to coupling mechanism 916. In some embodiments, coupling mechanism 916 can be configured to receive a top side of the watch body 920 (e.g., a side proximate to the front side of watch body 920 where display 905 is located) that is pushed upward into the cradle, as opposed to being pushed downward into coupling mechanism 916. In some embodiments, coupling mechanism 916 is an integrated component of wearable band 910 such that wearable band 910 and coupling mechanism 916 are a single unitary structure. In some embodiments, coupling mechanism 916 is a type of frame or shell that allows watch body 920 coupling surface to be retained within or on wearable band 910 coupling mechanism 916 (e.g., a cradle, a tracker band, a support base, a clasp, etc.).

Coupling mechanism 916 can allow for watch body 920 to be detachably coupled to the wearable band 910 through a friction fit, magnetic coupling, a rotation-based connector, a shear-pin coupler, a retention spring, one or more magnets, a clip, a pin shaft, a hook and loop fastener, or a combination thereof. A user can perform any type of motion to couple the watch body 920 to wearable band 910 and to decouple the watch body 920 from the wearable band 910. For example, a user can twist, slide, turn, push, pull, or rotate watch body 920 relative to wearable band 910, or a combination thereof, to attach watch body 920 to wearable band 910 and to detach watch body 920 from wearable band 910. Alternatively, as discussed below, in some embodiments, the watch body 920 can be decoupled from the wearable band 910 by actuation of a release mechanism 929.

Wearable band 910 can be coupled with watch body 920 to increase the functionality of wearable band 910 (e.g., converting wearable band 910 into wrist-wearable device 900, adding an additional computing unit and/or battery to increase computational resources and/or a battery life of wearable band 910, adding additional sensors to improve sensed data, etc.). As described above, wearable band 910 and coupling mechanism 916 are configured to operate independently (e.g., execute functions independently) from watch body 920. For example, coupling mechanism 916 can include one or more sensors 913 that contact a user's skin when wearable band 910 is worn by the user, with or without watch body 920 and can provide sensor data for determining control commands.

A user can detach watch body 920 from wearable band 910 to reduce the encumbrance of wrist-wearable device 900 to the user. For embodiments in which watch body 920 is removable, watch body 920 can be referred to as a removable structure, such that in these embodiments wrist-wearable device 900 includes a wearable portion (e.g., wearable band 910) and a removable structure (e.g., watch body 920).

Turning to watch body 920, in some examples watch body 920 can have a substantially rectangular or circular shape. Watch body 920 is configured to be worn by the user on their wrist or on another body part. More specifically, watch body 920 is sized to be easily carried by the user, attached on a portion of the user's clothing, and/or coupled to wearable band 910 (forming the wrist-wearable device 900). As described above, watch body 920 can have a shape corresponding to coupling mechanism 916 of wearable band 910. In some embodiments, watch body 920 includes a single release mechanism 929 or multiple release mechanisms (e.g., two release mechanisms 929 positioned on opposing sides of watch body 920, such as spring-loaded buttons) for decoupling watch body 920 from wearable band 910. Release mechanism 929 can include, without limitation, a button, a knob, a plunger, a handle, a lever, a fastener, a clasp, a dial, a latch, or a combination thereof.

A user can actuate release mechanism 929 by pushing, turning, lifting, depressing, shifting, or performing other actions on release mechanism 929. Actuation of release mechanism 929 can release (e.g., decouple) watch body 920 from coupling mechanism 916 of wearable band 910, allowing the user to use watch body 920 independently from wearable band 910 and vice versa. For example, decoupling watch body 920 from wearable band 910 can allow a user to capture images using rear-facing camera 925b. Although release mechanism 929 is shown positioned at a corner of watch body 920, release mechanism 929 can be positioned anywhere on watch body 920 that is convenient for the user to actuate. In addition, in some embodiments, wearable band 910 can also include a respective release mechanism for decoupling watch body 920 from coupling mechanism 916. In some embodiments, release mechanism 929 is optional and watch body 920 can be decoupled from coupling mechanism 916 as described above (e.g., via twisting, rotating, etc.).

Watch body 920 can include one or more peripheral buttons 923 and 927 for performing various operations at watch body 920. For example, peripheral buttons 923 and 927 can be used to turn on or wake (e.g., transition from a sleep state to an active state) display 905, unlock watch body 920, increase or decrease a volume, increase or decrease a brightness, interact with one or more applications, interact with one or more user interfaces, etc. Additionally or alternatively, in some embodiments, display 905 operates as a touch screen and allows the user to provide one or more inputs for interacting with watch body 920.

In some embodiments, watch body 920 includes one or more sensors 921. Sensors 921 of watch body 920 can be the same or distinct from sensors 913 of wearable band 910. Sensors 921 of watch body 920 can be distributed on an inside and/or an outside surface of watch body 920. In some embodiments, sensors 921 are configured to contact a user's skin when watch body 920 is worn by the user. For example, sensors 921 can be placed on the bottom side of watch body 920 and coupling mechanism 916 can be a cradle with an opening that allows the bottom side of watch body 920 to directly contact the user's skin. Alternatively, in some embodiments, watch body 920 does not include sensors that are configured to contact the user's skin (e.g., including sensors internal and/or external to the watch body 920 that are configured to sense data of watch body 920 and the surrounding environment). In some embodiments, sensors 921 are configured to track a position and/or motion of watch body 920.

Watch body 920 and wearable band 910 can share data using a wired communication method (e.g., a Universal Asynchronous Receiver/Transmitter (UART), a USB transceiver, etc.) and/or a wireless communication method (e.g., near field communication, Bluetooth, etc.). For example, watch body 920 and wearable band 910 can share data sensed by sensors 913 and 921, as well as application and device specific information (e.g., active and/or available applications, output devices (e.g., displays, speakers, etc.), input devices (e.g., touch screens, microphones, imaging sensors, etc.).

In some embodiments, watch body 920 can include, without limitation, a front-facing camera 925a and/or a rear-facing camera 925b, sensors 921 (e.g., a biometric sensor, an IMU, a heart rate sensor, a saturated oxygen sensor, a neuromuscular signal sensor, an altimeter sensor, a temperature sensor, a bioimpedance sensor, a pedometer sensor, an optical sensor (e.g., imaging sensor 1063), a touch sensor, a sweat sensor, etc.). In some embodiments, watch body 920 can include one or more haptic devices 1076 (e.g., a vibratory haptic actuator) that is configured to provide haptic feedback (e.g., a cutaneous and/or kinesthetic sensation, etc.) to the user. Sensors 1021 and/or haptic device 1076 can also be configured to operate in conjunction with multiple applications including, without limitation, health monitoring applications, social media applications, game applications, and artificial reality applications (e.g., the applications associated with artificial reality).

As described above, watch body 920 and wearable band 910, when coupled, can form wrist-wearable device 900. When coupled, watch body 920 and wearable band 910 may operate as a single device to execute functions (operations, detections, communications, etc.) described herein. In some embodiments, each device may be provided with particular instructions for performing the one or more operations of wrist-wearable device 900. For example, in accordance with a determination that watch body 920 does not include neuromuscular signal sensors, wearable band 910 can include alternative instructions for performing associated instructions (e.g., providing sensed neuromuscular signal data to watch body 920 via a different electronic device). Operations of wrist-wearable device 900 can be performed by watch body 920 alone or in conjunction with wearable band 910 (e.g., via respective processors and/or hardware components) and vice versa. In some embodiments, operations of wrist-wearable device 900, watch body 920, and/or wearable band 910 can be performed in conjunction with one or more processors and/or hardware components.

As described below with reference to the block diagram of FIG. 10, wearable band 910 and/or watch body 920 can each include independent resources required to independently execute functions. For example, wearable band 910 and/or watch body 920 can each include a power source (e.g., a battery), a memory, data storage, a processor (e.g., a central processing unit (CPU)), communications, a light source, and/or input/output devices.

FIG. 10 shows block diagrams of a computing system 1030 corresponding to wearable band 910 and a computing system 1060 corresponding to watch body 920 according to some embodiments. Computing system 1000 of wrist-wearable device 900 may include a combination of components of wearable band computing system 1030 and watch body computing system 1060, in accordance with some embodiments.

Watch body 920 and/or wearable band 910 can include one or more components shown in watch body computing system 1060. In some embodiments, a single integrated circuit may include all or a substantial portion of the components of watch body computing system 1060 included in a single integrated circuit. Alternatively, in some embodiments, components of the watch body computing system 1060 may be included in a plurality of integrated circuits that are communicatively coupled. In some embodiments, watch body computing system 1060 may be configured to couple (e.g., via a wired or wireless connection) with wearable band computing system 1030, which may allow the computing systems to share components, distribute tasks, and/or perform other operations described herein (individually or as a single device).

Watch body computing system 1060 can include one or more processors 1079, a controller 1077, a peripherals interface 1061, a power system 1095, and memory (e.g., a memory 1080).

Power system 1095 can include a charger input 1096, a power-management integrated circuit (PMIC) 1097, and a battery 1098. In some embodiments, a watch body 920 and a wearable band 910 can have respective batteries (e.g., battery 1098 and 1059) and can share power with each other. Watch body 920 and wearable band 910 can receive a charge using a variety of techniques. In some embodiments, watch body 920 and wearable band 910 can use a wired charging assembly (e.g., power cords) to receive the charge. Alternatively, or in addition, watch body 920 and/or wearable band 910 can be configured for wireless charging. For example, a portable charging device can be designed to mate with a portion of watch body 920 and/or wearable band 910 and wirelessly deliver usable power to battery 1098 of watch body 920 and/or battery 1059 of wearable band 910. Watch body 920 and wearable band 910 can have independent power systems (e.g., power system 1095 and 1056, respectively) to enable each to operate independently. Watch body 920 and wearable band 910 can also share power (e.g., one can charge the other) via respective PMICs (e.g., PMICs 1097 and 1058) and charger inputs (e.g., 1057 and 1096) that can share power over power and ground conductors and/or over wireless charging antennas.

In some embodiments, peripherals interface 1061 can include one or more sensors 1021. Sensors 1021 can include one or more coupling sensors 1062 for detecting when watch body 920 is coupled with another electronic device (e.g., a wearable band 910). Sensors 1021 can include one or more imaging sensors 1063 (e.g., one or more of cameras 1025, and/or separate imaging sensors 1063 (e.g., thermal-imaging sensors)). In some embodiments, sensors 1021 can include one or more SpO2 sensors 1064. In some embodiments, sensors 1021 can include one or more biopotential-signal sensors (e.g., EMG sensors 1065, which may be disposed on an interior, user-facing portion of watch body 920 and/or wearable band 910). In some embodiments, sensors 1021 may include one or more capacitive sensors 1066. In some embodiments, sensors 1021 may include one or more heart rate sensors 1067. In some embodiments, sensors 1021 may include one or more IMU sensors 1068. In some embodiments, one or more IMU sensors 1068 can be configured to detect movement of a user's hand or other location where watch body 920 is placed or held.

In some embodiments, one or more of sensors 1021 may provide an example human-machine interface. For example, a set of neuromuscular sensors, such as EMG sensors 1065, may be arranged circumferentially around wearable band 910 with an interior surface of EMG sensors 1065 being configured to contact a user's skin. Any suitable number of neuromuscular sensors may be used (e.g., between 2 and 20 sensors). The number and arrangement of neuromuscular sensors may depend on the particular application for which the wearable device is used. For example, wearable band 910 can be used to generate control information for controlling an augmented reality system, a robot, controlling a vehicle, scrolling through text, controlling a virtual avatar, or any other suitable control task.

In some embodiments, neuromuscular sensors may be coupled together using flexible electronics incorporated into the wireless device, and the output of one or more of the sensing components can be optionally processed using hardware signal processing circuitry (e.g., to perform amplification, filtering, and/or rectification). In other embodiments, at least some signal processing of the output of the sensing components can be performed in software such as processors 1079. Thus, signal processing of signals sampled by the sensors can be performed in hardware, software, or by any suitable combination of hardware and software, as aspects of the technology described herein are not limited in this respect.

Neuromuscular signals may be processed in a variety of ways. For example, the output of EMG sensors 1065 may be provided to an analog front end, which may be configured to perform analog processing (e.g., amplification, noise reduction, filtering, etc.) on the recorded signals. The processed analog signals may then be provided to an analog-to-digital converter, which may convert the analog signals to digital signals that can be processed by one or more computer processors. Furthermore, although this example is as discussed in the context of interfaces with EMG sensors, the embodiments described herein can also be implemented in wearable interfaces with other types of sensors including, but not limited to, mechanomyography (MMG) sensors, sonomyography (SMG) sensors, and electrical impedance tomography (EIT) sensors.

In some embodiments, peripherals interface 1061 includes a near-field communication (NFC) component 1069, a global-position system (GPS) component 1070, a long-term evolution (LTE) component 1071, and/or a Wi-Fi and/or Bluetooth communication component 1072. In some embodiments, peripherals interface 1061 includes one or more buttons 1073 (e.g., peripheral buttons 923 and 927 in FIG. 9), which, when selected by a user, cause operation to be performed at watch body 920. In some embodiments, the peripherals interface 1061 includes one or more indicators, such as a light emitting diode (LED), to provide a user with visual indicators (e.g., message received, low battery, active microphone and/or camera, etc.).

Watch body 920 can include at least one display 905 for displaying visual representations of information or data to a user, including user-interface elements and/or three-dimensional virtual objects. The display can also include a touch screen for inputting user inputs, such as touch gestures, swipe gestures, and the like. Watch body 920 can include at least one speaker 1074 and at least one microphone 1075 for providing audio signals to the user and receiving audio input from the user. The user can provide user inputs through microphone 1075 and can also receive audio output from speaker 1074 as part of a haptic event provided by haptic controller 1078. Watch body 920 can include at least one camera 1025, including a front camera 1025a and a rear camera 1025b. Cameras 1025 can include ultra-wide-angle cameras, wide angle cameras, fish-eye cameras, spherical cameras, telephoto cameras, depth-sensing cameras, or other types of cameras.

Watch body computing system 1060 can include one or more haptic controllers 1078 and associated componentry (e.g., haptic devices 1076) for providing haptic events at watch body 920 (e.g., a vibrating sensation or audio output in response to an event at the watch body 920). Haptic controllers 1078 can communicate with one or more haptic devices 1076, such as electroacoustic devices, including a speaker of the one or more speakers 1074 and/or other audio components and/or electromechanical devices that convert energy into linear motion such as a motor, solenoid, electroactive polymer, piezoelectric actuator, electrostatic actuator, or other tactile output generating components (e.g., a component that converts electrical signals into tactile outputs on the device). Haptic controller 1078 can provide haptic events to that are capable of being sensed by a user of watch body 920. In some embodiments, one or more haptic controllers 1078 can receive input signals from an application of applications 1082.

In some embodiments, wearable band computing system 1030 and/or watch body computing system 1060 can include memory 1080, which can be controlled by one or more memory controllers of controllers 1077. In some embodiments, software components stored in memory 1080 include one or more applications 1082 configured to perform operations at the watch body 920. In some embodiments, one or more applications 1082 may include games, word processors, messaging applications, calling applications, web browsers, social media applications, media streaming applications, financial applications, calendars, clocks, etc. In some embodiments, software components stored in memory 1080 include one or more communication interface modules 1083 as defined above. In some embodiments, software components stored in memory 1080 include one or more graphics modules 1084 for rendering, encoding, and/or decoding audio and/or visual data and one or more data management modules 1085 for collecting, organizing, and/or providing access to data 1087 stored in memory 1080. In some embodiments, one or more of applications 1082 and/or one or more modules can work in conjunction with one another to perform various tasks at the watch body 920.

In some embodiments, software components stored in memory 1080 can include one or more operating systems 1081 (e.g., a Linux-based operating system, an Android operating system, etc.). Memory 1080 can also include data 1087. Data 1087 can include profile data 1088A, sensor data 1089A, media content data 1090, and application data 1091.

It should be appreciated that watch body computing system 1060 is an example of a computing system within watch body 920, and that watch body 920 can have more or fewer components than shown in watch body computing system 1060, can combine two or more components, and/or can have a different configuration and/or arrangement of the components. The various components shown in watch body computing system 1060 are implemented in hardware, software, firmware, or a combination thereof, including one or more signal processing and/or application-specific integrated circuits.

Turning to the wearable band computing system 1030, one or more components that can be included in wearable band 910 are shown. Wearable band computing system 1030 can include more or fewer components than shown in watch body computing system 1060, can combine two or more components, and/or can have a different configuration and/or arrangement of some or all of the components. In some embodiments, all, or a substantial portion of the components of wearable band computing system 1030 are included in a single integrated circuit. Alternatively, in some embodiments, components of wearable band computing system 1030 are included in a plurality of integrated circuits that are communicatively coupled. As described above, in some embodiments, wearable band computing system 1030 is configured to couple (e.g., via a wired or wireless connection) with watch body computing system 1060, which allows the computing systems to share components, distribute tasks, and/or perform other operations described herein (individually or as a single device).

Wearable band computing system 1030, similar to watch body computing system 1060, can include one or more processors 1049, one or more controllers 1047 (including one or more haptics controllers 1048), a peripherals interface 1031 that can includes one or more sensors 1013 and other peripheral devices, a power source (e.g., a power system 1056), and memory (e.g., a memory 1050) that includes an operating system (e.g., an operating system 1051), data (e.g., data 1054 including profile data 1088B, sensor data 1089B, etc.), and one or more modules (e.g., a communications interface module 1052, a data management module 1053, etc.).

One or more of sensors 1013 can be analogous to sensors 1021 of watch body computing system 1060. For example, sensors 1013 can include one or more coupling sensors 1032, one or more SpO2 sensors 1034, one or more EMG sensors 1035, one or more capacitive sensors 1036, one or more heart rate sensors 1037, and one or more IMU sensors 1038.

Peripherals interface 1031 can also include other components analogous to those included in peripherals interface 1061 of watch body computing system 1060, including an NFC component 1039, a GPS component 1040, an LTE component 1041, a Wi-Fi and/or Bluetooth communication component 1042, and/or one or more haptic devices 1046 as described above in reference to peripherals interface 1061. In some embodiments, peripherals interface 1031 includes one or more buttons 1043, a display 1033, a speaker 1044, a microphone 1045, and a camera 1055. In some embodiments, peripherals interface 1031 includes one or more indicators, such as an LED.

It should be appreciated that wearable band computing system 1030 is an example of a computing system within wearable band 910, and that wearable band 910 can have more or fewer components than shown in wearable band computing system 1030, combine two or more components, and/or have a different configuration and/or arrangement of the components. The various components shown in wearable band computing system 1030 can be implemented in one or more of a combination of hardware, software, or firmware, including one or more signal processing and/or application-specific integrated circuits.

Wrist-wearable device 900 with respect to FIG. 9 is an example of wearable band 910 and watch body 920 coupled together, so wrist-wearable device 900 will be understood to include the components shown and described for wearable band computing system 1030 and watch body computing system 1060. In some embodiments, wrist-wearable device 900 has a split architecture (e.g., a split mechanical architecture, a split electrical architecture, etc.) between watch body 920 and wearable band 910. In other words, all of the components shown in wearable band computing system 1030 and watch body computing system 1060 can be housed or otherwise disposed in a combined wrist-wearable device 900 or within individual components of watch body 920, wearable band 910, and/or portions thereof (e.g., a coupling mechanism 916 of wearable band 910).

The techniques described above can be used with any device for sensing neuromuscular signals but could also be used with other types of wearable devices for sensing neuromuscular signals (such as body-wearable or head-wearable devices that might have neuromuscular sensors closer to the brain or spinal column).

In some embodiments, wrist-wearable device 900 can be used in conjunction with a head-wearable device (e.g., AR glasses 1100 and VR system 1210) and/or an HIPD described below, and wrist-wearable device 900 can also be configured to be used to allow a user to control any aspect of the artificial reality (e.g., by using EMG-based gestures to control user interface objects in the artificial reality and/or by allowing a user to interact with the touchscreen on the wrist-wearable device to also control aspects of the artificial reality). Having thus described example wrist-wearable devices, attention will now be turned to example head-wearable devices, such AR glasses 1100 and VR headset 1210.

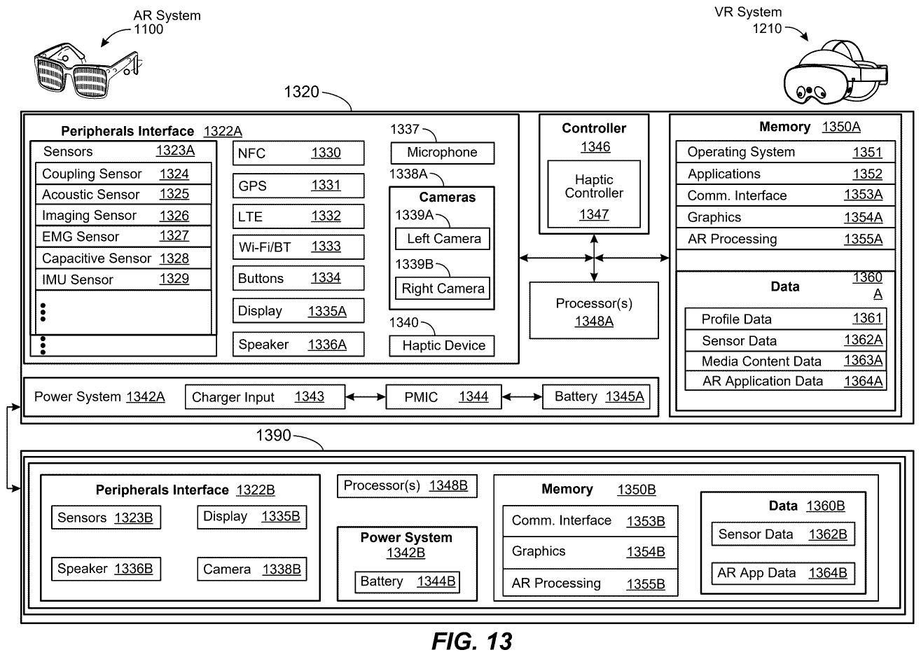

FIGS. 11 to 13 show example artificial-reality systems, which can be used as or in connection with wrist-wearable device 900. In some embodiments, AR system 1100 includes an eyewear device 1102, as shown in FIG. 11. In some embodiments, VR system 1210 includes a head-mounted display (HMD) 1212, as shown in FIGS. 12A and 12B. In some embodiments, AR system 1100 and VR system 1210 can include one or more analogous components (e.g., components for presenting interactive artificial-reality environments, such as processors, memory, and/or presentation devices, including one or more displays and/or one or more waveguides), some of which are described in more detail with respect to FIG. 13. As described herein, a head-wearable device can include components of eyewear device 1102 and/or head-mounted display 1212. Some embodiments of head-wearable devices do not include any displays, including any of the displays described with respect to AR system 1100 and/or VR system 1210. While the example artificial-reality systems are respectively described herein as AR system 1100 and VR system 1210, either or both of the example AR systems described herein can be configured to present fully-immersive virtual-reality scenes presented in substantially all of a user's field of view or subtler augmented-reality scenes that are presented within a portion, less than all, of the user's field of view.

FIG. 11 show an example visual depiction of AR system 1100, including an eyewear device 1102 (which may also be described herein as augmented-reality glasses, and/or smart glasses). AR system 1100 can include additional electronic components that are not shown in FIG. 11, such as a wearable accessory device and/or an intermediary processing device, in electronic communication or otherwise configured to be used in conjunction with the eyewear device 1102. In some embodiments, the wearable accessory device and/or the intermediary processing device may be configured to couple with eyewear device 1102 via a coupling mechanism in electronic communication with a coupling sensor 1324 (FIG. 13), where coupling sensor 1324 can detect when an electronic device becomes physically or electronically coupled with eyewear device 1102. In some embodiments, eyewear device 1102 can be configured to couple to a housing 1390 (FIG. 13), which may include one or more additional coupling mechanisms configured to couple with additional accessory devices. The components shown in FIG. 11 can be implemented in hardware, software, firmware, or a combination thereof, including one or more signal-processing components and/or application-specific integrated circuits (ASICs).

Eyewear device 1102 includes mechanical glasses components, including a frame 1104 configured to hold one or more lenses (e.g., one or both lenses 1106-1 and 1106-2). One of ordinary skill in the art will appreciate that eyewear device 1102 can include additional mechanical components, such as hinges configured to allow portions of frame 1104 of eyewear device 1102 to be folded and unfolded, a bridge configured to span the gap between lenses 1106-1 and 1106-2 and rest on the user's nose, nose pads configured to rest on the bridge of the nose and provide support for eyewear device 1102, earpieces configured to rest on the user's ears and provide additional support for eyewear device 1102, temple arms configured to extend from the hinges to the earpieces of eyewear device 1102, and the like. One of ordinary skill in the art will further appreciate that some examples of AR system 1100 can include none of the mechanical components described herein. For example, smart contact lenses configured to present artificial reality to users may not include any components of eyewear device 1102.

Eyewear device 1102 includes electronic components, many of which will be described in more detail below with respect to FIG. 13. Some example electronic components are illustrated in FIG. 11, including acoustic sensors 1125-1, 1125-2, 1125-3, 1125-4, 1125-5, and 1125-6, which can be distributed along a substantial portion of the frame 1104 of eyewear device 1102. Eyewear device 1102 also includes a left camera 1139A and a right camera 1139B, which are located on different sides of the frame 1104. Eyewear device 1102 also includes a processor 1148 (or any other suitable type or form of integrated circuit) that is embedded into a portion of the frame 1104.

FIGS. 12A and 12B show a VR system 1210 that includes a head-mounted display (HMD) 1212 (e.g., also referred to herein as an artificial-reality headset, a head-wearable device, a VR headset, etc.), in accordance with some embodiments. As noted, some artificial-reality systems (e.g., AR system 1100) may, instead of blending an artificial reality with actual reality, substantially replace one or more of a user's visual and/or other sensory perceptions of the real world with a virtual experience (e.g., AR systems 700 and 800).

HMD 1212 includes a front body 1214 and a frame 1216 (e.g., a strap or band) shaped to fit around a user's head. In some embodiments, front body 1214 and/or frame 1216 include one or more electronic elements for facilitating presentation of and/or interactions with an AR and/or VR system (e.g., displays, IMUs, tracking emitter or detectors). In some embodiments, HMD 1212 includes output audio transducers (e.g., an audio transducer 1218), as shown in FIG. 12B. In some embodiments, one or more components, such as the output audio transducer(s) 1218 and frame 1216, can be configured to attach and detach (e.g., are detachably attachable) to HMD 1212 (e.g., a portion or all of frame 1216, and/or audio transducer 1218), as shown in FIG. 12B. In some embodiments, coupling a detachable component to HMD 1212 causes the detachable component to come into electronic communication with HMD 1212.

FIGS. 12A and 12B also show that VR system 1210 includes one or more cameras, such as left camera 1239A and right camera 1239B, which can be analogous to left and right cameras 1139A and 1139B on frame 1104 of eyewear device 1102. In some embodiments, VR system 1210 includes one or more additional cameras (e.g., cameras 1239C and 1239D), which can be configured to augment image data obtained by left and right cameras 1239A and 1239B by providing more information. For example, camera 1239C can be used to supply color information that is not discerned by cameras 1239A and 1239B. In some embodiments, one or more of cameras 1239A to 1239D can include an optional IR cut filter configured to remove IR light from being received at the respective camera sensors.

FIG. 13 illustrates a computing system 1320 and an optional housing 1390, each of which show components that can be included in AR system 1100 and/or VR system 1210. In some embodiments, more or fewer components can be included in optional housing 1390 depending on practical restraints of the respective AR system being described.

In some embodiments, computing system 1320 can include one or more peripherals interfaces 1322A and/or optional housing 1390 can include one or more peripherals interfaces 1322B. Each of computing system 1320 and optional housing 1390 can also include one or more power systems 1342A and 1342B, one or more controllers 1346 (including one or more haptic controllers 1347), one or more processors 1348A and 1348B (as defined above, including any of the examples provided), and memory 1350A and 1350B, which can all be in electronic communication with each other. For example, the one or more processors 1348A and 1348B can be configured to execute instructions stored in memory 1350A and 1350B, which can cause a controller of one or more of controllers 1346 to cause operations to be performed at one or more peripheral devices connected to peripherals interface 1322A and/or 1322B. In some embodiments, each operation described can be powered by electrical power provided by power system 1342A and/or 1342B.

In some embodiments, peripherals interface 1322A can include one or more devices configured to be part of computing system 1320, some of which have been defined above and/or described with respect to the wrist-wearable devices shown in FIGS. 9 and 10. For example, peripherals interface 1322A can include one or more sensors 1323A. Some example sensors 1323A include one or more coupling sensors 1324, one or more acoustic sensors 1325, one or more imaging sensors 1326, one or more EMG sensors 1327, one or more capacitive sensors 1328, one or more IMU sensors 1329, and/or any other types of sensors explained above or described with respect to any other embodiments discussed herein.

In some embodiments, peripherals interfaces 1322A and 1322B can include one or more additional peripheral devices, including one or more NFC devices 1330, one or more GPS devices 1331, one or more LTE devices 1332, one or more Wi-Fi and/or Bluetooth devices 1333, one or more buttons 1334 (e.g., including buttons that are slidable or otherwise adjustable), one or more displays 1335A and 1335B, one or more speakers 1336A and 1336B, one or more microphones 1337, one or more cameras 1338A and 1338B (e.g., including the left camera 1339A and/or a right camera 1339B), one or more haptic devices 1340, and/or any other types of peripheral devices defined above or described with respect to any other embodiments discussed herein.

AR systems can include a variety of types of visual feedback mechanisms (e.g., presentation devices). For example, display devices in AR system 1100 and/or VR system 1210 can include one or more liquid-crystal displays (LCDs), light emitting diode (LED) displays, organic LED (OLED) displays, and/or any other suitable types of display screens. Artificial-reality systems can include a single display screen (e.g., configured to be seen by both eyes), and/or can provide separate display screens for each eye, which can allow for additional flexibility for varifocal adjustments and/or for correcting a refractive error associated with a user's vision. Some embodiments of AR systems also include optical subsystems having one or more lenses (e.g., conventional concave or convex lenses, Fresnel lenses, or adjustable liquid lenses) through which a user can view a display screen.

For example, respective displays 1335A and 1335B can be coupled to each of the lenses 1106-1 and 1106-2 of AR system 1100. Displays 1335A and 1335B may be coupled to each of lenses 1106-1 and 1106-2, which can act together or independently to present an image or series of images to a user. In some embodiments, AR system 1100 includes a single display 1335A or 1335B (e.g., a near-eye display) or more than two displays 1335A and 1335B. In some embodiments, a first set of one or more displays 1335A and 1335B can be used to present an augmented-reality environment, and a second set of one or more display devices 1335A and 1335B can be used to present a virtual-reality environment. In some embodiments, one or more waveguides are used in conjunction with presenting artificial-reality content to the user of AR system 1100 (e.g., as a means of delivering light from one or more displays 1335A and 1335B to the user's eyes). In some embodiments, one or more waveguides are fully or partially integrated into the eyewear device 1102. Additionally, or alternatively to display screens, some artificial-reality systems include one or more projection systems. For example, display devices in AR system 1100 and/or VR system 1210 can include micro-LED projectors that project light (e.g., using a waveguide) into display devices, such as clear combiner lenses that allow ambient light to pass through. The display devices can refract the projected light toward a user's pupil and can enable a user to simultaneously view both artificial-reality content and the real world. Artificial-reality systems can also be configured with any other suitable type or form of image projection system. In some embodiments, one or more waveguides are provided additionally or alternatively to the one or more display(s) 1335A and 1335B.

Computing system 1320 and/or optional housing 1390 of AR system 1100 or VR system 1210 can include some or all of the components of a power system 1342A and 1342B. Power systems 1342A and 1342B can include one or more charger inputs 1343, one or more PMICs 1344, and/or one or more batteries 1345A and 1344B.

Memory 1350A and 1350B may include instructions and data, some or all of which may be stored as non-transitory computer-readable storage media within the memories 1350A and 1350B. For example, memory 1350A and 1350B can include one or more operating systems 1351, one or more applications 1352, one or more communication interface applications 1353A and 1353B, one or more graphics applications 1354A and 1354B, one or more AR processing applications 1355A and 1355B, and/or any other types of data defined above or described with respect to any other embodiments discussed herein.

Memory 1350A and 1350B also include data 1360A and 1360B, which can be used in conjunction with one or more of the applications discussed above. Data 1360A and 1360B can include profile data 1361, sensor data 1362A and 1362B, media content data 1363A, AR application data 1364A and 1364B, and/or any other types of data defined above or described with respect to any other embodiments discussed herein.

In some embodiments, controller 1346 of eyewear device 1102 may process information generated by sensors 1323A and/or 1323B on eyewear device 1102 and/or another electronic device within AR system 1100. For example, controller 1346 can process information from acoustic sensors 1125-1 and 1125-2. For each detected sound, controller 1346 can perform a direction of arrival (DOA) estimation to estimate a direction from which the detected sound arrived at eyewear device 1102 of AR system 1100. As one or more of acoustic sensors 1325 (e.g., the acoustic sensors 1125-1, 1125-2) detects sounds, controller 1346 can populate an audio data set with the information (e.g., represented in FIG. 13 as sensor data 1362A and 1362B).

In some embodiments, a physical electronic connector can convey information between eyewear device 1102 and another electronic device and/or between one or more processors 1148, 1348A, 1348B of AR system 1100 or VR system 1210 and controller 1346. The information can be in the form of optical data, electrical data, wireless data, or any other transmittable data form. Moving the processing of information generated by eyewear device 1102 to an intermediary processing device can reduce weight and heat in the eyewear device, making it more comfortable and safer for a user. In some embodiments, an optional wearable accessory device (e.g., an electronic neckband) is coupled to eyewear device 1102 via one or more connectors. The connectors can be wired or wireless connectors and can include electrical and/or non-electrical (e.g., structural) components. In some embodiments, eyewear device 1102 and the wearable accessory device can operate independently without any wired or wireless connection between them.

In some situations, pairing external devices, such as an intermediary processing device (e.g., HIPD 506, 606, 706) with eyewear device 1102 (e.g., as part of AR system 1100) enables eyewear device 1102 to achieve a similar form factor of a pair of glasses while still providing sufficient battery and computation power for expanded capabilities. Some, or all, of the battery power, computational resources, and/or additional features of AR system 1100 can be provided by a paired device or shared between a paired device and eyewear device 1102, thus reducing the weight, heat profile, and form factor of eyewear device 1102 overall while allowing eyewear device 1102 to retain its desired functionality. For example, the wearable accessory device can allow components that would otherwise be included on eyewear device 1102 to be included in the wearable accessory device and/or intermediary processing device, thereby shifting a weight load from the user's head and neck to one or more other portions of the user's body. In some embodiments, the intermediary processing device has a larger surface area over which to diffuse and disperse heat to the ambient environment. Thus, the intermediary processing device can allow for greater battery and computation capacity than might otherwise have been possible on eyewear device 1102 standing alone. Because weight carried in the wearable accessory device can be less invasive to a user than weight carried in the eyewear device 1102, a user may tolerate wearing a lighter eyewear device and carrying or wearing the paired device for greater lengths of time than the user would tolerate wearing a heavier eyewear device standing alone, thereby enabling an artificial-reality environment to be incorporated more fully into a user's day-to-day activities.

AR systems can include various types of computer vision components and subsystems. For example, AR system 1100 and/or VR system 1210 can include one or more optical sensors such as two-dimensional (2D) or three-dimensional (3D) cameras, time-of-flight depth sensors, structured light transmitters and detectors, single-beam or sweeping laser rangefinders, 3D LiDAR sensors, and/or any other suitable type or form of optical sensor. An AR system can process data from one or more of these sensors to identify a location of a user and/or aspects of the use's real-world physical surroundings, including the locations of real-world objects within the real-world physical surroundings. In some embodiments, the methods described herein are used to map the real world, to provide a user with context about real-world surroundings, and/or to generate digital twins (e.g., interactable virtual objects), among a variety of other functions. For example, FIGS. 12A and 12B show VR system 1210 having cameras 1239A to 1239D, which can be used to provide depth information for creating a voxel field and a two-dimensional mesh to provide object information to the user to avoid collisions.

In some embodiments, AR system 1100 and/or VR system 1210 can include haptic (tactile) feedback systems, which may be incorporated into headwear, gloves, body suits, handheld controllers, environmental devices (e.g., chairs or floormats), and/or any other type of device or system, such as the wearable devices discussed herein. The haptic feedback systems may provide various types of cutaneous feedback, including vibration, force, traction, shear, texture, and/or temperature. The haptic feedback systems may also provide various types of kinesthetic feedback, such as motion and compliance. The haptic feedback may be implemented using motors, piezoelectric actuators, fluidic systems, and/or a variety of other types of feedback mechanisms. The haptic feedback systems may be implemented independently of other artificial-reality devices, within other artificial-reality devices, and/or in conjunction with other artificial-reality devices.

In some embodiments of an artificial reality system, such as AR system 1100 and/or VR system 1210, ambient light (e.g., a live feed of the surrounding environment that a user would normally see) can be passed through a display element of a respective head-wearable device presenting aspects of the AR system. In some embodiments, ambient light can be passed through a portion less that is less than all of an AR environment presented within a user's field of view (e.g., a portion of the AR environment co-located with a physical object in the user's real-world environment that is within a designated boundary (e.g., a guardian boundary) configured to be used by the user while they are interacting with the AR environment). For example, a visual user interface element (e.g., a notification user interface element) can be presented at the head-wearable device, and an amount of ambient light (e.g., 15-50% of the ambient light) can be passed through the user interface element such that the user can distinguish at least a portion of the physical environment over which the user interface element is being displayed.

In some examples, the augmented reality systems described herein may also include a microphone array with a plurality of acoustic transducers. Acoustic transducers may represent transducers that detect air pressure variations induced by sound waves. Each acoustic transducer may be configured to detect sound and convert the detected sound into an electronic format (e.g., an analog or digital format). A microphone array may include, for example, ten acoustic transducers that may be designed to be placed inside a corresponding ear of the user, acoustic transducers that may be positioned at various locations on an HMD frame a watch band, etc.

In some embodiments, one or more of acoustic transducers may be used as output transducers (e.g., speakers). For example, the artificial reality systems described herein may include acoustic transducers that are earbuds or any other suitable type of headphone or speaker.

The configuration of acoustic transducers of a microphone array may vary and may include any suitable number of transducers. In some embodiments, using higher numbers of acoustic transducers may increase the amount of audio information collected and/or the sensitivity and accuracy of the audio information. In contrast, using a lower number of acoustic transducers may decrease the computing power required by an associated controller to process the collected audio information. In addition, the position of each acoustic transducer of the microphone array may vary. For example, the position of an acoustic transducer may include a defined position on the user, a defined coordinate on a frame of an HMD, an orientation associated with each acoustic transducer, or some combination thereof.

Acoustic transducers and may be positioned on different parts of the user's ear, such as behind the pinna, behind the tragus, and/or within the auricle or fossa. Or, there may be additional acoustic transducers on or surrounding the ear in addition to acoustic transducers inside the ear canal. Having an acoustic transducer positioned next to an ear canal of a user may enable the microphone array to collect information on how sounds arrive at the ear canal. By positioning at least two of acoustic transducers on either side of a user's head (e.g., as binaural microphones), an artificial-reality device may simulate binaural hearing and capture a 3D stereo sound field around about a user's head. In some embodiments, acoustic transducers may be connected to artificial reality systems via a wired connection, and in other embodiments acoustic transducers may be connected to artificial-reality systems via a wireless connection (e.g., a BLUETOOTH connection).

Acoustic transducers may be positioned on HMDs frames in a variety of different ways, including along the length of the temples, across the bridge, above or below display devices, or some combination thereof. Acoustic transducers may also be oriented such that the microphone array is able to detect sounds in a wide range of directions surrounding the user wearing the augmented-reality system. In some embodiments, an optimization process may be performed during manufacturing of augmented-reality system to determine relative positioning of each acoustic transducer in the microphone array.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
driving a near-eye display including a single image panel partitioned into left- and right-eye regions and respective independently controllable illumination subsystems;
sensing an operating condition of the near-eye display;
determining, for each of the left- and right-eye regions, an illumination window based at least in part on a refresh state of that region and the operating condition; and
commanding the illumination subsystems to emit during the determined illumination windows while coordinating per-region emission timing to satisfy inter-ocular alignment and mitigate display-induced motion artifacts.

2. The method of claim 1, wherein the operating condition comprises at least temperature.

3. The method of claim 1, wherein the operating condition comprises at least one of ambient temperature, panel temperature, refresh rate, supply voltage, illumination subsystem temperature, or panel age.

4. The method of claim 1, wherein the refresh state comprises at least one of a scanout position, a line or row index, a region update completion indicator, or a frame boundary indicator.

5. The method of claim 1, further comprising:
modeling, for each of the left- and right-eye regions, a response characteristic of the image panel as a function of the operating condition, and
determining the illumination window based at least in part on a settling time obtained from the model.

6. The method of claim 1, wherein coordinating the per-region emission timing comprises enforcing an inter-ocular temporal disparity constraint.

7. The method of claim 6, wherein the inter-ocular temporal disparity constraint comprises a maximum allowable time offset between the illumination windows.

8. The method of claim 1, wherein the illumination subsystems comprise independently controllable backlights.

9. The method of claim 1, wherein the illumination subsystems comprise segmented illumination sources that are independently strobed for the left- and right-eye regions.

10. The method of claim 1, wherein the illumination windows overlap in time.

11. The method of claim 1, further comprising content-adaptively modulating an illumination duty within at least one illumination window.

12. The method of claim 11, further comprising compensating perceived brightness responsive to duty modulation by adjusting effective luminance via at least one of pixel drive or illumination amplitude.

13. The method of claim 1, further comprising sensing a motion state of the near-eye display or a user head pose and, based at least in part on the motion state, adjusting the per-region emission timing.

14. The method of claim 1, wherein sensing the operating condition comprises reading at least one temperature sensor coupled to the image panel or an illumination subsystem.

15. The method of claim 1, further comprising reducing motion-to-photon latency by advancing at least one illumination window while maintaining the inter-ocular alignment.

16. The method of claim 1, further comprising adjusting a data link rate or pipeline scheduling to align the refresh state with the coordinated emission timing.

17. The method of claim 1, further comprising performing chromatic aberration correction and coordinating the per-region emission timing to account for processing latency.

18. The method of claim 1, wherein the single image panel is rotated relative to an optical axis such that the refresh state of the left- and right-eye regions progresses in opposite directions.

19. A system comprising:
at least one physical processor;
physical memory comprising computer-executable instructions that, when executed by the physical processor, cause the physical processor to:
drive a near-eye display including a single image panel partitioned into left- and right-eye regions and respective independently controllable illumination subsystems;
sense an operating condition of the near-eye display;
determine, for each region, an illumination window based at least in part on a refresh state of that region and the operating condition; and
command the illumination subsystems to emit during the determined illumination windows while coordinating per-region emission timing to satisfy inter-ocular alignment and mitigate display-induced motion artifacts.

20. A non-transitory computer-readable medium comprising one or more computer-executable instructions that, when executed by at least one processor of a computing device, cause the computing device to:
drive a near-eye display including a single image panel partitioned into left- and right-eye regions and respective independently controllable illumination subsystems;
sense an operating condition of the near-eye display;
determine, for each region, an illumination window based at least in part on a refresh state of that region and the operating condition; and
command the illumination subsystems to emit during the determined illumination windows while coordinating per-region emission timing to satisfy inter-ocular alignment and mitigate display-induced motion artifacts.
